(19) United States
(12) Patent Application Publication
(10) Pub. No.: US 2024/0073982 A1
(43) Pub. Date: Feb. 29, 2024

(54) MEASUREMENT CONFIGURATION FOR DEACTIVATED SECONDARY CELL GROUP

(71) Applicant: Telefonaktiebolaget LM Ericsson (PUBL), Stockholm (SE)

(72) Inventors: Pontus Wallentin, LINKÖPING (SE); Joakim Axmon, LIMHAMN (SE); Cecilia Eklöf, TÄBY (SE); Jens Bergqvist, LINKÖPING (SE)

(21) Appl. No.: 18/261,136

(22) PCT Filed: Jan. 13, 2022
(86) PCT No.: PCT/SE2022/050025

§ 371 Date: Jul. 12, 2023

Related U.S. Application Data
(60) Provisional application No. 63/137,207, filed on Jan. 14, 2021.

(51) Int. Cl. H04W 76/15; H04W 24/08

(52) U.S. Cl. CPC H04W 76/15; H04W 24/08; H04W 88/06

(57) ABSTRACT

According to some embodiments, a method is performed by a wireless device (110) configured to operate in multi-radio dual connectivity, MR-DC, to perform measurements in a deactivated secondary cell group, SCG, mode of operation. The method comprises obtaining a measurement configuration for use in a deactivated SCG mode of operation. The measurement configuration is more relaxed than a measurement configuration for use in an activated SCG mode of operation. The method further comprises, when in deactivated SCG mode of operation, performing measurements and measurement reporting in the deactivated SCG according to the obtained measurement configuration.

### TECHNICAL FIELD

Embodiments of the present disclosure are directed to wireless communications and, more particularly to multiple-radio dual connectivity (MR-DC) and measurement configuration for a deactivated secondary cell group.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Particular embodiments may be described with respect to Third Generation Partnership Project (3GPP) long term evolution (LTE) and/or fifth generation (5G) new radio (NR) wireless networks, but the embodiments are applicable to other wireless networks as well.

Some wireless networks include carrier aggregation (CA). When carrier aggregation is configured, a user equipment (UE) only has one radio resource control (RRC) connection with the network. Further, at RRC connection establishment/re-establishment/handover, one serving cell provides the non-access stratum (NAS) mobility information, and at RRC connection re-establishment/handover, one serving cell provides the security input. The cell is referred to as the primary cell (PCell). In addition, depending on UE capabilities, secondary cells (SCells) may be configured to form together with the PCell a set of serving cells. Therefore, when carrier aggregation is configured for the UE, the set of serving cells used by the UE consists of one PCell and one or more SCells.

The reconfiguration, addition and removal of SCells can be performed by RRC. At intra-radio access technology (RAT) handover, RRC can also add, remove, or reconfigure SCells for use with the target PCell. When adding a new SCell, dedicated RRC signaling is used for sending the required system information of the SCell, i.e., while in connected mode, UEs need not acquire broadcasted system information directly from the SCells.

Some wireless networks also include dual connectivity (DC). LTE dual connectivity enables a UE to be connected in two cell groups, each controlled by an LTE access node, eNBs, referred to as the master eNB, MeNB, and the secondary eNB, SeNB. The UE only has one RRC connection with the network. In 3GPP, the dual connectivity solution has evolved and is now also specified for NR as well as between LTE and NR. Multi-connectivity (MC) is the case when there are more than two nodes involved. With introduction of 5G, the term multi-radio dual connectivity (MR-DC) (see 3GPP TS 37.340) is a generic term for all dual connectivity options that include at least one NR access node. Using the MR-DC generalized terminology, the UE is connected in a master cell group (MCG), controlled by the master node (MN), and in a secondary cell group (SCG) controlled by a secondary node (SN).

Further, in MR-DC, when dual connectivity is configured for the UE, within each of the two cell groups, MCG and SCG, carrier aggregation may be used as well. In this case, within the MCG controlled by the MN, the UE may use one PCell and one or more SCell(s). Within the SCG controlled by the SN, the UE may use one Primary SCell (PSCell, also known as the primary SCG cell in NR) and one or more SCell(s). An example is illustrated in FIG. 1.

FIG. 1 is a functional diagram illustrating dual connectivity combined with carrier aggregation in MR-DC. The master cell group includes a PCell and a plurality of SCells. The secondary cell group includes a PSCell and a plurality of SCells.

In NR, the primary cell of a master or secondary cell group may also be referred to as the Special Cell (SpCell). Thus, the SpCell in the MCG is the PCell and the SpCell in the SCG is the PSCell.

There are different ways to deploy 5G network with or without interworking with LTE (also referred to as E-UTRA) and evolved packet core (EPC). In principle, NR and LTE may be deployed without any interworking, denoted by NR stand-alone (SA) operation, also known as Option 2, that is gNB in NR can be connected to 5G core network (5GC) and eNB in LTE can be connected to EPC with no interconnection between the two, also known as Option 1.

On the other hand, the first supported version of NR uses dual connectivity, denoted as EN-DC (E-UTRAN-NR Dual Connectivity), also known as Option 3, as depicted in FIG. 2.

FIG. 2 is a block diagram illustrating EN-DC. In such a deployment, dual connectivity between NR and LTE is applied, where the UE is connected with both the LTE radio interface (LTE Uu in FIG. 2) to an LTE access node and the NR radio interface (NR Uu in FIG. 2) to an NR access node.

Further, in EN-DC, the LTE access node acts as the master node (also referred to as the Master eNB, MeNB), controlling the master cell group and the NR access node acts as the secondary node (also referred to as the Secondary gNB, SgNB), controlling the secondary cell group. The SgNB may not have a control plane connection to the core network (EPC) which instead is provided by the MeNB and in this case NR. This is also referred to as “Non-standalone NR” or, in short, “NSA NR”. In this case the functionality of an NR cell is limited and is used for connected mode UEs as a booster and/or diversity leg, but an RRC_IDLE UE cannot camp on the NR cells.

With introduction of 5GC, other options may be also valid. As mentioned above, option 2 supports stand-alone NR deployment where gNB is connected to 5GC. Similarly, LTE may also be connected to 5GC using option 5 (also known as eLTE, E-UTRA/5GC, or LTE/5GC and the node may be referred to as an ng-eNB). In these cases, both NR and LTE are seen as part of the NG-RAN (and both the ng-eNB and the gNB can be referred to as NG-RAN nodes).

There are also other variants of dual connectivity between LTE and NR which have been standardized as part of NG-RAN connected to 5GC. The MR-DC umbrella includes:
EN-DC (Option 3): LTE is the master node and NR is the secondary node (EPC CN employed, as depicted in FIG. 2)
NE-DC (Option 4): NR is the master node and LTE is the secondary (SGCN employed)
NGEN-DC (Option 7): LTE is the master node and NR is the secondary (SGCN employed)
NR-DC (variant of Option 2): Dual connectivity where both the master node, MN, controlling the MCG, and the secondary node, SN, controlling the SCG, are NR (SGCN employed, as depicted in FIG. 3).

FIG. 3 is a block diagram illustrating NR-DC. Both the master node and the secondary node are NR nodes connected to the 5GC.

As migration for these options may differ from different operators, it is possible to have deployments with multiple options in parallel in the same network. For example, an eNB base station may support option 3, 5 and 7 in the same network as a NR base station supporting 2 and 4. In combination with dual connectivity solutions between LTE and NR, it is also possible to support carrier aggregation in each cell group (i.e., MCG and SCG) and dual connectivity between nodes on the same RAT (e.g., NR-NR DC). For LTE cells, a consequence of these different deployments is the co-existence of LTE cells associated to eNBs connected to EPC, 5GC or both EPC/5GC.

As described above, DC is standardized for both LTE and E-UTRA-NR DC (EN-DC).

LTE DC and EN-DC are designed differently when it comes to which nodes control what. The two options are centralized solutions (like LTE-DC) and decentralized solutions (like EN-DC).

FIG. 4 illustrates the schematic control plane architecture for LTE DC, EN-DC and NR-DC. The main difference is that in EN-DC and NR-DC, the SN has a separate NR RRC entity. This means that the SN can control the UE also; sometimes without the knowledge of the MN but often the SN needs to coordinate with the MN. In LTE-DC, the RRC decisions are always coming from the MN (MN to UE). Note however, the SN still decides the configuration of the SN, because it is only the SN itself that has knowledge of what kind of resources, capabilities, etc. it has.

For EN-DC and NR-DC, the major changes compared to LTE DC are the introduction of split bearer from the SN (known as SCG split bearer), the introduction of split bearer for RRC, and the introduction of a direct RRC from the SN (also referred to as SCG SRB).

FIG. 5 illustrates, from network perspective, the user plane protocol architecture in MR-DC with EPC (EN-DC). In this case, the network can configure either E-UTRA PDCP or NR PDCP for MN terminated MCG bearers while NR PDCP is always used for all other bearers.

FIG. 6 illustrates, from network perspective, the user plane protocol architecture in MR-DC with 5GC (NGEN-DC, NE-DC and NR-DC). In MR-DC with 5GC, NR PDCP is always used for all bearer types. In NGEN-DC, E-UTRA RLC/MAC is used in the MN while NR RLC/MAC is used in the SN. In NE-DC, NR RLC/MAC is used in the MN while E-UTRA RLC/MAC is used in the SN. In NR-DC, NR RLC/MAC is used in both MN and SN.

Packet data convergence protocol (PDCP) packet duplication, also known as packet duplication or PDCP duplication, is a feature that may be used to support ultra-reliable low latency (URLLC) use-cases. PDCP duplication is configurable in both carrier aggregation (CA) as well as dual connectivity (DC).

According to 3GPP TS 38.300 v16.1, and depicted in FIG. 7, when duplication is configured for a radio bearer by RRC, at least one secondary RLC entity is added to the radio bearer to handle the duplicated PDCP PDUs, where the logical channel corresponding to the primary RLC entity is referred to as the primary logical channel, and the logical channel corresponding to the secondary RLC entity(ies) is referred to as the secondary logical channel(s).

Duplication at PDCP includes submitting the same PDCP PDUs multiple times, once to each activated RLC entity for the radio bearer. The packet duplicates are transmitted via the different carriers (cells). With multiple independent transmission paths, packet duplication therefore increases reliability and reduces latency and is especially beneficial for URLLC services.

When configuring duplication for a DRB, RRC also sets the state of PDCP duplication (either activated or deactivated) at the time of (re-)configuration. After the configuration, the PDCP duplication state may then be dynamically controlled by means of a MAC control element and in DC, the UE applies the MAC CE commands regardless of their origin (MCG or SCG).

Some networks may include SCG power saving mode. To improve network energy efficiency and UE battery life for UEs in MR-DC, some networks may include efficient SCG/SCell activation/deactivation. This can be especially important for MR-DC configurations with NR SCG, because in some cases NR UE power consumption is 3 to 4 times higher than LTE.

3GPP has specified the concepts of dormant SCell (in LTE) and dormancy like behavior of an SCell (for NR). In LTE, when an SCell is in dormant state, like in the deactivated state, the UE does not need to monitor the corresponding PDCCH or PDSCH and cannot transmit in the corresponding uplink. However, different from the deactivated state, the UE is required to perform and report CQI measurements. A PUCCH SCell (SCell configured with PUCCH) cannot be in dormant state.

In NR, dormancy like behavior for SCells is realized using the concept of dormant BWPs. One dormant BWP, which is one of the dedicated BWPs configured by the network via RRC signaling, may be configured for an SCell. If the active BWP of the activated SCell is a dormant BWP, the UE stops monitoring PDCCH on the SCell but continues performing CSI measurements, AGC and beam management, if configured. A DCI is used to control entering/leaving the dormant BWP for one or more SCell(s) or one or more SCell group(s), and it is sent to the special cell (sPCell) of the cell group that the SCell belongs to (i.e., PCell in case the SCell belongs to the MCG and PSCell if the SCell belongs to the SCG). The SpCell (i.e., PCell of PSCell) and PUCCH SCell cannot be configured with a dormant BWP. An example is illustrated in FIG. 8.

However, only SCells can be put in dormant state (in LTE) or operate in dormancy like behavior (NR). Also, only SCells can be put into the deactivated state in both LTE and NR. Thus, if the UE is configured with MR-DC, it is not possible to fully benefit from the power saving options of dormant state or dormancy like behavior because the PSCell cannot be configured with that feature. Instead, an existing solution may be releasing (for power savings) and adding (when traffic demands requires) the SCG on an as needed basis. However, traffic is likely to be bursty, and adding and releasing the SCG involves a significant amount of RRC signaling and inter-node messaging between the MN and the SN, which causes considerable delay.

In Release 16 (Rel-16) standardization activity, consideration was given regarding putting the PSCell in dormancy, also referred to as SCG Suspension. Some preliminary agreements are that the UE supports network-controlled suspension of the SCG in RRC_CONNECTED. The UE supports at most one SCG configuration, suspended or not suspended. In RRC_CONNECTED upon addition of the SCG, the SCG can be either suspended or not suspended by configuration.

Some solutions have been proposed in Rel-16, but these have different problems. For example, contribution R2-1908679 (Introducing suspension of SCG) proposes that a gNB can indicate to a UE to suspend SCG transmissions when no data traffic is expected to be sent in SCG so that the UE keeps the SCG configuration but does not use it for power saving purpose. Signaling to suspend the SCG may be based on DCI/MAC-CE/RRC signaling, but no details were provided regarding the configuration from the gNB to the UE. And, different from the defined behavior for SCell(s), the PSCell may be associated to a different network node (e.g., a gNodeB operating as secondary node).

SCG power saving in Release 17 (Rel-17) may include one or more of the following agreements. The UE starting to operate the PSCell in dormancy, e.g. switching the PSCell to a dormant BWP. On the network side, the network considers the PSCell in dormancy and at least stops transmitting PDCCH for that UE in the PSCell and SCells.

The UE deactivating the PSCell like SCell deactivation. On the network side, the network considers the PSCell as deactivated and at least stops transmitting PDCCH for that UE in the PSCell (and also on the SCells).

The UE operating the PSCell in long DRX. SCG DRX can be switched off from the MN (e.g., via MCG RRC, MAC CE or DCI) when the need arises (e.g., downlink data arrival for SN terminated SCG bearers).

The UE suspending its operation with the SCG (e.g., suspending bearers associated with the SCG, like SCG MN-/SN-terminated bearers), but keeping the SCG configuration stored (referred to as Stored SCG). On the network side there can be different alternatives such as the SN storing the SCG as the UE does, or the SN releasing the SCG context of the UE to be generated again upon resume (e.g., with the support from the MN that is the node storing the SCG context for that UE whose SCG is suspended).

Though the power saving aspect is so far discussed from the SCG point of view, it is likely that similar approaches may be used on the MCG as well (e.g., the MCG may be suspended or in long DRX, while data communication is happening only via the SCG). 3GPP discussions on solutions for the Rel-17 MR-DC work item objective “Support efficient activation/de-activation mechanism for one SCG and Scells” have started. One objective is investigating the concept of a “deactivated SCG” for power saving when the traffic demands are dynamically reduced.

As FIG. 9 illustrates, there are two SCG states (sometimes referred to as states for SCG activation) being discussed, referred to as “SCG deactivated state” and “SCG activated state”. These states concern the power saving mode for the SCG and should not be confused with the RRC states.

One assumption is that during “SCG deactivated state”, or sometimes referred to as “SCG is deactivated”, to save power, the UE does not perform PDCCH monitoring of the PSCell. This also means that uplink/downlink data transmission in the SCG is suspended when the SCG is in SCG deactivated state. When the SCG is in what is referred to as “SCG activated state” the power saving of the SCG is not applied. Activation and deactivation of the SCG is typically controlled by the network, e.g. by the MN, using RRC signaling.

As a baseline, MN-configured RRM measurement/reporting procedures do not depend on the SCG activation state (deactivated or activated). Further optimizations are not precluded.

While the SCG is deactivated, PSCell mobility is supported. MN- and SN-configured measurements are supported for deactivated SCG.

In RRC_CONNECTED, the UE may be configured to perform RRM measurements and report them to the network according to configured criteria (e.g., periodic, or event-triggered). The measurement reports are typically used to support L3 decisions taken by the network, e.g., handovers, reconfiguration with sync, PSCell addition, PSCell change, release with redirect, etc.

In RRC_CONNECTED, the UE measures multiple beams (at least one) of a cell and the measurement results (power values) are averaged to derive the cell quality. In doing so, the UE is configured to consider a subset of the detected beams. Filtering takes place at two different levels: at the physical layer to derive beam quality and then at RRC level to derive cell quality from multiple beams. Cell quality from beam measurements is derived in the same way for the serving cell(s) and for the non-serving cell(s). Measurement reports may contain the measurement results of the X best beams if the UE is configured to do so by the gNB. The corresponding high-level measurement model is described with respect to FIG. 10.

FIG. 10 is a block diagram illustrating beam measurement and reporting. K beams correspond to the measurements on SSB or CSI-RS resources configured for L3 mobility by gNB and detected by UE at Ll.

Layer 1 filtering introduces a certain level of measurement averaging. How and when the UE performs the required measurements is implementation specific to the point that the output at B fulfils the performance requirements set in TS 38.133. Layer 3 filtering for cell quality and related parameters used are specified in TS 38.331 and do not introduce any delay in the sample availability between B and C. Measurement at point C, C¹ is the input used in the event evaluation. L3 beam filtering and related parameters used are specified in TS 38.331 and do not introduce any delay in the sample availability between E and F.

Measurement reports include the measurement identity of the associated measurement configuration that triggered the reporting. The network configures the cell and beam measurement quantities to be included in measurement reports. The number of non-serving cells to be reported may be limited through configuration by the network. Cells belonging to a blacklist configured by the network are not used in event evaluation and reporting, Conversely, when a whitelist is configured by the network, only the cells belonging to the whitelist are used in event evaluation and reporting. Beam measurements to be included in measurement reports are configured by the network (beam identifier only, measurement result and beam identifier, or no beam reporting).

The network may request the UE to measure NR and/or E-UTRA carriers in RRC_IDLE or RRC_INACTIVE via system information or via dedicated measurement configuration in RRCRelease. If the UE was configured to perform measurements of NR and/or E-UTRA carriers while in RRC_IDLE, it may provide an indication of the availability of corresponding measurement results to the gNB in the RRCSetupComplete message. The network may request the UE to report those measurements after security activation. The request for the measurements may be sent by the network immediately after transmitting the Security Mode Command (i.e., before the reception of the Security Mode Complete from the UE).

If the UE was configured to perform measurements of NR and/or E-UTRA carriers while in RRC_INACTIVE, the gNB may request the UE to provide corresponding measurement results in the RRCResume message and then the UE can include the available measurement results in the RRCResumeComplete message. Alternatively, the UE may provide an indication of the availability of the measurement results to the gNB in the RRCResumeComplete message and the gNB may then request the UE to provide these measurement results.

The network may configure the UE to perform the following types of RRM measurements: NR measurements; inter-RAT measurements of E-UTRA frequencies; and inter-RAT measurements of UTRA-FDD frequencies.

The RRM measurement configuration includes the following parameters:

1. Measurement objects: A list of objects on which the UE shall perform the measurements. For intra-frequency and inter-frequency measurements, a measurement object indicates the frequency/time location and subcarrier spacing of reference signals to be measured. Associated with this measurement object, the network may configure a list of cell specific offsets, a list of ‘blacklisted’ cells and a list of ‘whitelisted’ cells. Blacklisted cells are not applicable in event evaluation or measurement reporting. Whitelisted cells are the only ones applicable in event evaluation or measurement reporting.

The measObjectld of the measurement object that corresponds to each serving cell is indicated by servingCellMO within the serving cell configuration.

For inter-RAT E-UTRA measurements, a measurement object is a single E-UTRA carrier frequency. Associated with this E-UTRA carrier frequency, the network may configure a list of cell specific offsets, a list of ‘blacklisted’ cells and a list of ‘whitelisted’ cells. Blacklisted cells are not applicable in event evaluation or measurement reporting. Whitelisted cells are the only ones applicable in event evaluation or measurement reporting.

For inter-RAT UTRA-FDD measurements, a measurement object is a set of cells on a single UTRA-FDD carrier frequency.

For CBR measurement of NR sidelink communication, a measurement object is a set of transmission resource pool(s) on a single carrier frequency for NR sidelink communication.

For CLI measurements, a measurement object indicates the frequency/time location of SRS resources and/or CLI-RSSI resources, and subcarrier spacing of SRS resources to be measured.

2. Reporting configurations: A list of reporting configurations where there can be one or multiple reporting configurations per measurement object. Each measurement reporting configuration consists of the following:
Reporting criterion: The criterion that triggers the UE to send a measurement report. This can either be periodical or a single event description.
RS type: The RS that the UE uses for beam and cell measurement results (SS/PBCH block or CSI-RS).
Reporting format: The quantities per cell and per beam that the UE includes in the measurement report (e.g., RSRP) and other associated information such as the maximum number of cells and the maximum number beams per cell to report.
For conditional reconfiguration triggering configuration, each configuration consists of the following:
   Execution criteria: The criteria that triggers the UE to perform conditional reconfiguration execution.
   RS type: The RS that the UE uses for beam and cell measurement results (SS/PBCH block or CSI-RS) for conditional reconfiguration execution condition.

3. Measurement identities: Measurement reporting includes a list of measurement identities where each measurement identity links one measurement object with one reporting configuration. By configuring multiple measurement identities, it is possible to link more than one measurement object to the same reporting configuration, as well as to link more than one reporting configuration to the same measurement object. The measurement identity is also included in the measurement report that triggered the reporting, serving as a reference to the network. For conditional reconfiguration triggering, one measurement identity links to one conditional reconfiguration trigger configuration. Up to two measurement identities may be linked to one conditional reconfiguration execution condition.

4. Quantity configurations: The quantity configuration defines the measurement filtering configuration used for all event evaluation and related reporting, and for periodical reporting of the measurement. For NR measurements, the network may configure up to two quantity configurations with a reference in the NR measurement object to the configuration that is to be used. In each configuration, different filter coefficients may be configured for different measurement quantities, for different RS types, and for measurements per cell and per beam.

5. Measurement gaps: Periods that the UE may use to perform measurements.

Whenever the procedural specification, other than contained in sub-clause 5.5.2, refers to a field it concerns a field included in the VarMeasConfig unless explicitly stated otherwise, i.e., only the measurement configuration procedure covers the direct UE action related to the received measConfig.

In NR-DC, the UE may receive two independent measConfig: a measConfig associated with MCG that is included in the RRCReconfiguration message received via SRB1; and a measConfig associated with SCG that is included in the RRCReconfiguration message received via SRB3, or, alternatively, included within a RRCReconfiguration message embedded in a RRCReconfiguration message received via SRB1.

In this case, the UE maintains two independent VarMeasConfig and VarMeasReportList, one associated with each measConfig, and independently performs all the procedures in clause 5.5 for each measConfig and the associated VarMeasConfig and VarMeasReportList, unless explicitly stated otherwise.

The configurations related to CBR measurements are only included in the measConfig associated with MCG.

The UE receives a measurement configuration and performs measurements according to what is configured in measConfig in RRCReconfiguration. Each measurement configuration is associated with a measurement ID, measID, and a measurement object, measObjectNR. The UE reports the results of the measurements according to what is configured in reportConfig in RRCReconfiguration.

From chapter 6.3.2 in TS 38.331, The IE MeasConfig specifies measurements to be performed by the UE, and covers intra-frequency, inter-frequency and inter-RAT mobility as well as configuration of measurement gaps.

MeasConfig information element

-- ASN1START
-- TAG-MEASCONFIG-START

| | |
|---|---|
| MeasConfig ::= | SEQUENCE { |
| measObjectToRemoveList | MeasObjectToRemoveList |

OPTIONAL, -- Need N

| | |
|---|---|
| measObjectToAddModList | MeasObjectToAddModList |

OPTIONAL, -- Need N

| | |
|---|---|
| reportConfigToRemoveList | ReportConfigToRemoveList |

OPTIONAL, -- Need N

| | |
|---|---|
| reportConfigToAddModList | ReportConfigToAddModList |

OPTIONAL, -- Need N

| | |
|---|---|
| measIdToRemoveList | MeasIdToRemoveList |

OPTIONAL, -- Need N

| | |
|---|---|
| measIdToAddModList | MeasIdToAddModList |

OPTIONAL, -- Need N

| | |
|---|---|
| s-MeasureConfig | CHOICE { |
| ssb-RSRP | RSRP-Range, |
| csi-RSRP | RSRP-Range |

}
OPTIONAL, -- Need M

| | |
|---|---|
| quantityConfig | QuantityConfig |

OPTIONAL, -- Need M

| | |
|---|---|
| measGapConfig | MeasGapConfig |

OPTIONAL, -- Need M

| | |
|---|---|
| measGapSharingConfig | MeasGapSharingConfig |

```
OPTIONAL, -- Need M
  ...,
  [[
```

| | |
|---|---|
| interFrequencyConfig-NoGap-r16 | ENUMERATED {true} |

OPTIONAL -- Need R
]]
}

| | |
|---|---|
| MeasObjectToRemoveList ::= | SEQUENCE (SIZE (1..maxNrofObjectId)) OF MeasObjectId |
| MeasIdToRemoveList ::= | SEQUENCE (SIZE (1..maxNrofMeasId)) OF MeasId |
| ReportConfigToRemoveList ::= | SEQUENCE (SIZE (1..maxReportConfigId)) OF |

ReportConfigId
-- TAG-MEASCONFIG-STOP
-- ASN1STOP

MeasConfig field descriptions

interFrequencyConfig-NoGap-r16
If the field is set to true, UE is configured to perform SSB based
inter-frequency measurement without measurement gaps when the
inter-frequency SSB is completely contained in the active DL BWP
of the UE, as specified in TS 38.133, clause 9.3.
Otherwise, the SSB based inter-frequency measurement is performed
within measurement gaps.
measGapConfig
Used to setup and release measurement gaps in NR.
measIdToAddModList
List of measurement identities to add and/or modify.
measIdToRemoveList
List of measurement identities to remove.
measObjectToAddModList
List of measurement objects to add and/or modify.
measObjectToRemoveList
List of measurement objects to remove.
reportConfigToAddModList
List of measurement reporting configurations to add and/or modify.
reportConfigToRemoveList
List of measurement reporting configurations to remove.
s-MeasureConfig
Threshold for NR SpCell RSRP measurement controlling when the
UE is required to perform measurements on non-serving cells.
Choice of ssb-RSRP corresponds to cell RSRP based on SS/PBCH
block and choice of csi-RSRP corresponds to cell RSRP of CSI-RS.
measGapSharingConfig
Specifies the measurement gap sharing scheme and controls
setup/release of measurement gap sharing.

For deactivated SCell, 3GPP has defined a way to relax the measurement cycle with the parameter measCycleSCell.

-- TAG-MEASOBJECTNR-START

| | |
|---|---|
| MeasObjectNR ::= | SEQUENCE { |
| ssbFrequency | ARFCN-ValueNR |

OPTIONAL, -- Cond SSBorAssociatedSSB

| | |
|---|---|
| ssbSubcarrierSpacing | SubcarrierSpacing |

OPTIONAL, -- Cond SSBorAssociatedSSB

| | |
|---|---|
| smtc1 | SSB-MTC |

OPTIONAL, -- Cond SSBorAssociatedSSB

| | |
|---|---|
| smtc2 | SSB-MTC2 |

OPTIONAL, -- IntraFreqConnected

| | |
|---|---|
| refFreqCSI-RS | ARFCN-ValueNR |

OPTIONAL, -- CoCondnd CSI-RS

| | |
|---|---|
| referenceSignalConfig | ReferenceSignalConfig, |
| absThreshSS-BlocksConsolidation | ThresholdNR |

OPTIONAL, -- Need R

| | |
|---|---|
| absThreshCSI-RS-Consolidation | ThresholdNR |

OPTIONAL, -- Need R

| | |
|---|---|
| nrofSS-BlocksToAverage | INTEGER (2..maxNrofSS-BlocksToAverage) |

OPTIONAL, -- Need R

| | |
|---|---|
| nrofCSI-RS-ResourcesToAverage | INTEGER (2..maxNrofCSI-RS-ResourcesToAverage) |

OPTIONAL, -- Need R

| | |
|---|---|
| quantityConfigIndex | INTEGER (1..maxNrofQuantityConfig), |
| offsetMO | Q-OffsetRangeList, |
| cellsToRemoveList | PCI-List |

OPTIONAL, -- Need N

| | |
|---|---|
| cellsToAddModList | CellsToAddModList |

OPTIONAL, -- Need N

| | |
|---|---|
| blackCellsToRemoveList | PCI-RangeIndexList |

OPTIONAL, -- Need N

| | |
|---|---|
| blackCellsToAddModList | SEQUENCE (SIZE (1..maxNrofPCI-Ranges)) OF PCI- |

RangeElement OPTIONAL, -- Need N

| | |
|---|---|
| whiteCellsToRemoveList | PCI-RangeIndexList |

OPTIONAL, -- Need N

| | |
|---|---|
| whiteCellsToAddModList | SEQUENCE (SIZE (1..maxNrofPCI-Ranges)) OF PCI- |

```
RangeElement OPTIONAL, -- Need N
  ...,
  [[
```

| | |
|---|---|
| freqBandIndicatorNR | FreqBandIndicatorNR |

OPTIONAL, -- Need R

| | |
|---|---|
| measCycleSCell | ENUMERATED {sf160, sf256, sf320, sf512, sf640, sf1024, |

```
sf1280} OPTIONAL -- Need R
  ]],
  [[
```

| | |
|---|---|
| smtc3list-r16 | SSB-MTC3List-r16 |

OPTIONAL, -- Need R

| | |
|---|---|
| rmtc-Config-r16 | SetupRelease {RMTC-Config-r16} |

OPTIONAL, -- Need M

| | |
|---|---|
| t312-r16 | SetupRelease { T312-r16 } |

OPTIONAL -- Need M
]]
}

The measCycleSCell parameter is used only when an SCell is configured on the frequency indicated by the measObjectNR and is in deactivated state, see TS 38.133. The gNB configures the parameter whenever an SCell is configured on the frequency indicated by the measObjectNR, but the field may also be signalled when an SCell is not configured. Value sf160 corresponds to 160 sub-frames, value sf256 corresponds to 256 sub-frames and so on. The UE uses measurement gaps to perform measurements when it cannot measure the target carrier frequency while simultaneously transmitting/receiving on the serving cell.

For LTE, the UE uses measurement gaps to perform inter-frequency and inter-RAT measurements. A measurement gap is defined by the gap length and periodicity. In LTE, the typical gap length is 6 ms (which is equivalent to a 5 ms measurement time, assuming RF re-tuning time of 0.5 ms before and after the measurement gap). This is sufficient in LTE because the PSS and SSS are transmitted once every 5 ms. The measurement gap periodicity can be either 40 ms or 80 ms.

In NR, measurements gaps might be required for intra-frequency (e.g., if the intra-frequency measurements are to be done outside of the active BWP), inter-frequency and inter-RAT measurements. Measurement gap lengths of 1.5, 3, 3.5, 4, 5.5, and 6 ms with measurement gap repetition periodicities of 20, 40, 80, and 160 ms are defined in NR.

In NR, the RF re-tuning time is 0.5 ms for carrier frequency measurements in FR1 range and 0.25 ms for FR2 range. For example, a gap length of 4 ms for FR1 measurements allows 3 ms for actual measurements and a gap length of 3.5 ms for FR2 measurements allows 3 ms for actual measurements.

During the measurement gaps, the measurements are to be performed on SSBs of the neighbour cells. The network provides the timing of neighbour cell SSBs using SS/PBCH Block Measurement Timing Configuration (SMTC). The measurement gap and SMTC duration are configured such that the UE can identify and measure the SSBs within the SMTC window, i.e., the SMTC duration is sufficient to accommodate all SSBs that are being transmitted.

For SSB based intra-frequency measurements, the network configures a measurement gap if any of the UE configured BWPs do not contain the frequency domain resources of the SSB associated to the initial downlink BWP.

For SSB based inter-frequency measurements, the network configures a measurement gap if the UE supports per-FR measurement gaps (i.e., separate RF chains for FR1 and FR2, meaning performing measurements on the gap interrupts the Tx/Rx on the corresponding frequency range, FR) and if the carrier frequency to be measured is in same FR as any of the serving cells. The network also configures a measurement gap if the UE only supports per-UE measurement gaps (i.e., common RF chain for FR1 and FR2, meaning performing measurements interrupts tx/rx on both frequency ranges). In this case, the measurement object can be configured on any frequency range (FR1 or FR2) but the gap will anyway be configured by the network.

Inter-RAT measurements in NR are limited to E-UTRA. For a UE configured with E-UTRA Inter-RAT measurements, a measurement gap configuration is provided when the UE only supports per-UE measurement gaps or the UE supports per-FR measurement gaps and at least one of the NR serving cells is in FR1.

RRC_CONNECTED requirements for intra-frequency measurements on detectable cells are defined in terms of a number of cells and number of SSBs per frequency range, and measurement reporting requirements, for at least one of the following: periodic reporting, event-triggered periodic reporting, and event-triggered reporting. The requirements also include accuracy of a measurement, defined per frequency range e.g. accuracy of SS-RSRP, and measurement reporting delay. More details can be found in TS 38.133.

There currently exist certain challenges. For example, in legacy procedures (Rel-16), the measurements defined in measConfig are applicable to the activated SCG. With the introduction of a SCG deactivated mode of operation, also referred to as deactivated SCG, to reduce the UE power consumption, it may be beneficial to configure different measurements for deactivated SCG compared to activated SCG or other ways of restricting the measurements. In the current configuration, it is not possible to distinguish which measurements are applicable for activated SCG and which are applicable for deactivated SCG.

### SUMMARY

As described above, certain challenges currently exist with multiple-radio dual connectivity (MR-DC) and measurement configuration for a deactivated secondary cell group (SCG). Certain aspects of the present disclosure and their embodiments may provide solutions to these or other challenges. Particular embodiments include methods for configuring and performing measurements for deactivated SCG mode of operation.

In some embodiments, a user equipment (UE) configured in MR-DC obtains a measurement configuration subset for use in deactivated SCG mode of operation. When in deactivated SCG mode of operation, the UE performs measurements according to the obtained measurement configuration subset. In particular embodiments, the measurement configuration subset is a fixed measurement configuration subset. In particular embodiments, the measurement configuration subset is a configured subset of measurements.

In some embodiments, the UE configured in MR-DC obtains a measurement cycle configuration for use in deactivated SCG mode of operation. When in deactivated SCG mode of operation, the UE performs measurements according to the obtained measurement cycle configuration. In particular embodiments, the measurement cycle configuration is a set of different relaxed measurement cycles for different measurement objects. In particular embodiments, the measurement cycle configuration is a measCycleSCell extended to include Primary SCell (PSCell).

In general, a method for a UE configured in MR-DC, to perform measurements in deactivated SCG mode of operation, comprises obtaining a measurement configuration subset for use in deactivated SCG mode of operation. When in deactivated SCG mode of operation, the method comprises performing measurements according to the obtained measurement configuration subset. Another method for a UE configured in MR-DC, to perform measurements in deactivated SCG mode of operation, comprises obtaining a measurement cycle configuration for use in deactivated SCG mode of operation. When in deactivated SCG mode of operation, the method further comprises performing measurements according to the measurement cycle configuration.

According to some embodiments, a method is performed by a wireless device configured to operate in MR-DC to perform measurements in a deactivated SCG mode of operation. The method comprises obtaining a measurement configuration for use in a deactivated SCG mode of operation. The measurement configuration is more relaxed than a measurement configuration for use in an activated SCG mode of operation. The method further comprises, when in deactivated SCG mode of operation, performing measurements and measurement reporting in the deactivated SCG according to the obtained measurement configuration.

In particular embodiments, the measurement configuration for use in deactivated SCG mode of operation comprises a subset of a measurement configuration for use in activated SCG mode of operation. The subset may comprise one or more of: a subset of cells to measure; a subset of frequencies to measure; and a subset of measurement objects.

In particular embodiments, the measurement configuration for use in deactivated SCG mode of operation comprises a measurement cycle (e.g., for PSCell or SCell).

In particular embodiments, the measurement configuration for use in deactivated SCG mode of operation further comprises one or more threshold values associated with one or more configurations. The measurement configuration for use in deactivated SCG mode of operation may comprise a first measurement configuration for use with a first group of one or more cells and a second measurement configuration for use with a second group of one or more cells.

According to some embodiments, a wireless device comprises processing circuitry operable to perform any of the wireless device methods described above.

Also disclosed is a computer program product comprising a non-transitory computer readable medium storing computer readable program code, the computer readable program code operable, when executed by processing circuitry to perform any of the methods performed by the wireless device described above.

According to some embodiments, a method is performed by a network node configured to communicate with a wireless device operating in MR-DC and operable to perform measurements in a deactivated SCG mode of operation. The method comprises obtaining a measurement configuration for the wireless device for use in a deactivated SCG mode of operation. The measurement configuration is more relaxed than a measurement configuration for use in an activated SCG mode of operation. The method further comprises transmitting the measurement configuration to the wireless device. The method may also comprise receiving measurement reporting from the wireless device according to the measurement configuration.

In particular embodiments, the measurement configuration for use in deactivated SCG mode of operation comprises a subset of a measurement configuration for use in activated SCG mode of operation. The subset may comprise one or more of: a subset of cells to measure; a subset of frequencies to measure; and a subset of measurement objects.

In particular embodiments, the measurement configuration for use in deactivated SCG mode of operation comprises a measurement cycle (e.g., for PSCell or SCell).

In particular embodiments, the measurement configuration for use in deactivated SCG mode of operation further comprises one or more threshold values associated with one or more configurations. The measurement configuration for use in deactivated SCG mode of operation may comprise a first measurement configuration for use with a first group of one or more cells and a second measurement configuration for use with a second group of one or more cells.

According to some embodiments, a network node comprises processing circuitry operable to perform any of the network node methods described above.

Also disclosed is a computer program product comprising a non-transitory computer readable medium storing computer readable program code, the computer readable program code operable, when executed by processing circuitry to perform any of the methods performed by the network node described above.

Certain embodiments may provide one or more of the following technical advantages. For example, particular embodiments facilitate configuration of different measurements for activated SCG mode of operation and deactivated SCG mode of operation.

Another advantage of some embodiments is that when the SCG is deactivated, the UE performs fewer measurements, .e.g., by measuring on fewer measurement objects (e.g., frequencies) and/or spending less time to perform the measurements. This in turn reduces UE battery consumption. Particular embodiments may also facilitate configuration of the UE with fewer measurement gaps, which in turn may increase the data throughput for the UE.

Particular embodiments enable the UE to prioritize the measurements in SCG deactivated state, which ensures that the UE has a good radio link with the SCG when the SCG becomes activated again.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a functional diagram illustrating dual connectivity combined with carrier aggregation in MR-DC;

FIG. 2 is a block diagram illustrating EN-DC;

FIG. 3 is a block diagram illustrating NR-DC;

FIG. 4 illustrates the schematic control plane architecture for LTE DC, EN-DC and NR-DC;

FIG. 5 illustrates network side protocol termination options for MCG, SCG and split bearers in MR-DC with EPC (EN-DC);

FIG. 6 illustrates network side protocol termination options for MCG, SCG and split bearers in MR-DC with 5GC (NGEN-DC, NE-DC and NR-DC);

FIG. 7 is a block diagram illustrating PDCP packet duplication;

FIG. 8 is a state diagram illustrating dormancy like behavior for SCells in NR;

FIG. 9 is a state diagram illustrating SCG states for power saving;

FIG. 10 is a block diagram illustrating beam measurement and reporting;

FIG. 11 is a block diagram illustrating an example wireless network;

FIG. 12 illustrates an example user equipment, according to certain embodiments;

FIG. 13 is flowchart illustrating an example method in a wireless device, according to certain embodiments;

FIG. 14 is flowchart illustrating an example method in a network node, according to certain embodiments;

FIG. 15 illustrates a schematic block diagram of a wireless device and a network node in a wireless network, according to certain embodiments;

FIG. 16 illustrates an example virtualization environment, according to certain embodiments;

FIG. 17 illustrates an example telecommunication network connected via an intermediate network to a host computer, according to certain embodiments;

FIG. 18 illustrates an example host computer communicating via a base station with a user equipment over a partially wireless connection, according to certain embodiments;

FIG. 19 is a flowchart illustrating a method implemented, according to certain embodiments;

FIG. 20 is a flowchart illustrating a method implemented in a communication system, according to certain embodiments;

FIG. 21 is a flowchart illustrating a method implemented in a communication system, according to certain embodiments; and

FIG. 22 is a flowchart illustrating a method implemented in a communication system, according to certain embodiments.

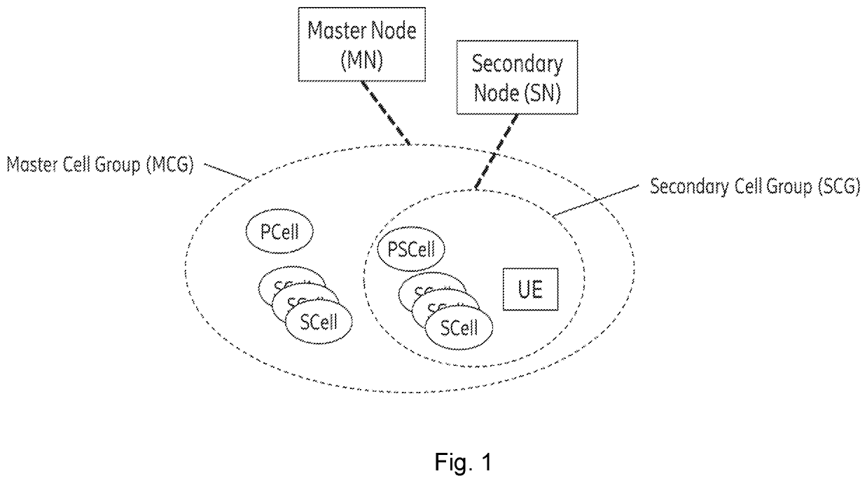

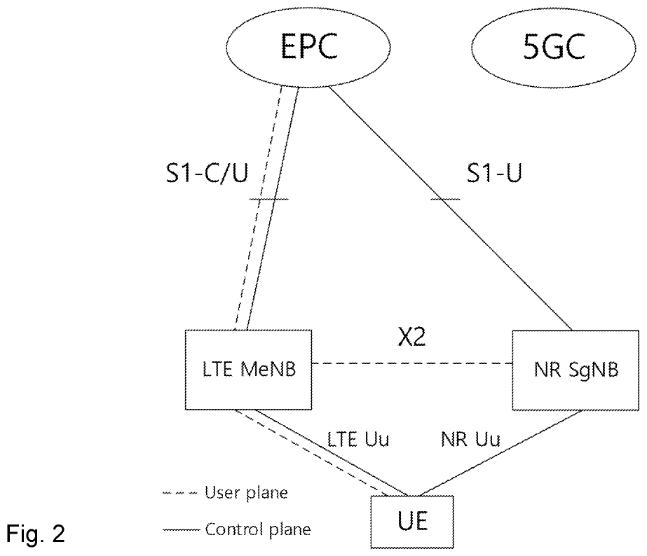

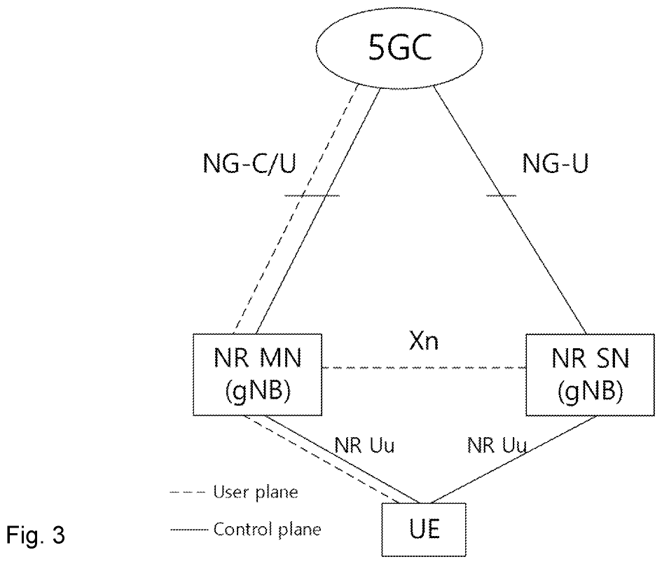

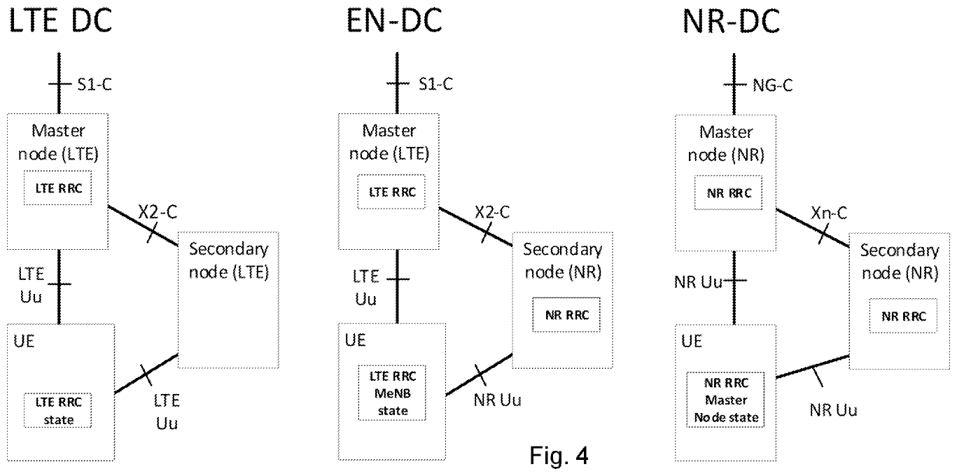

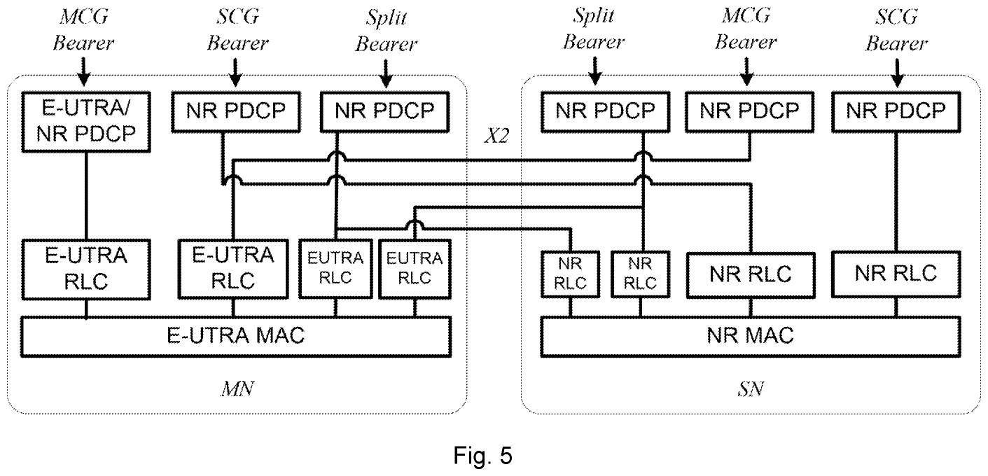

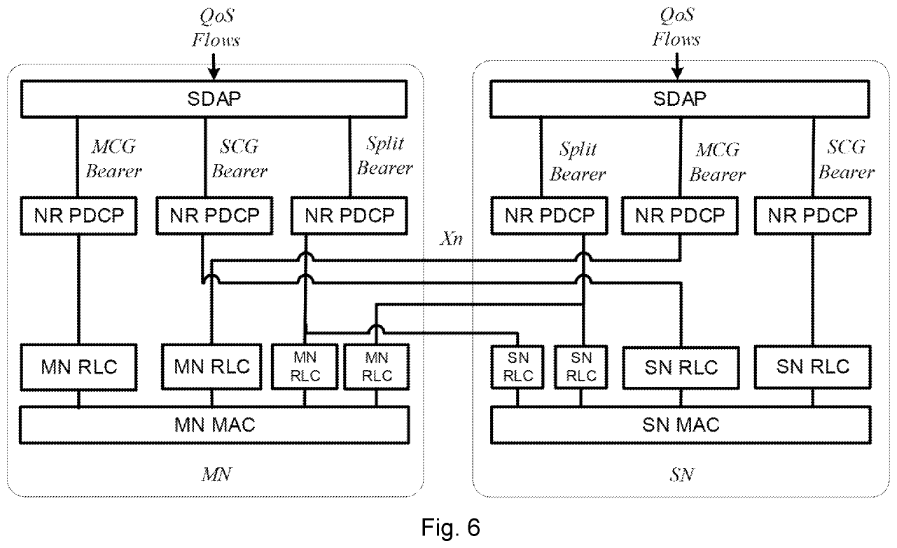

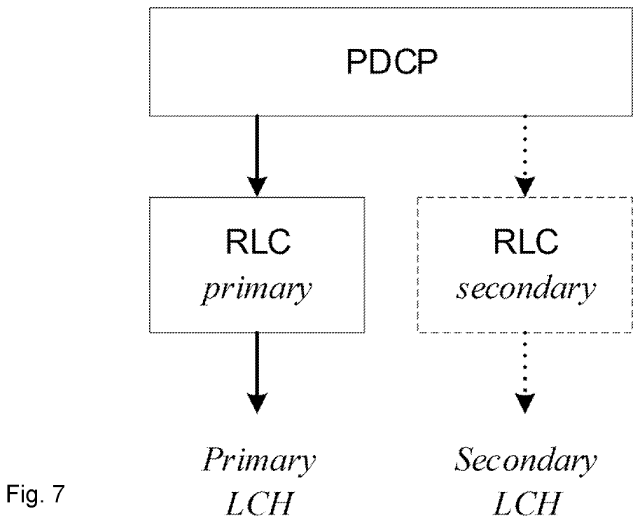

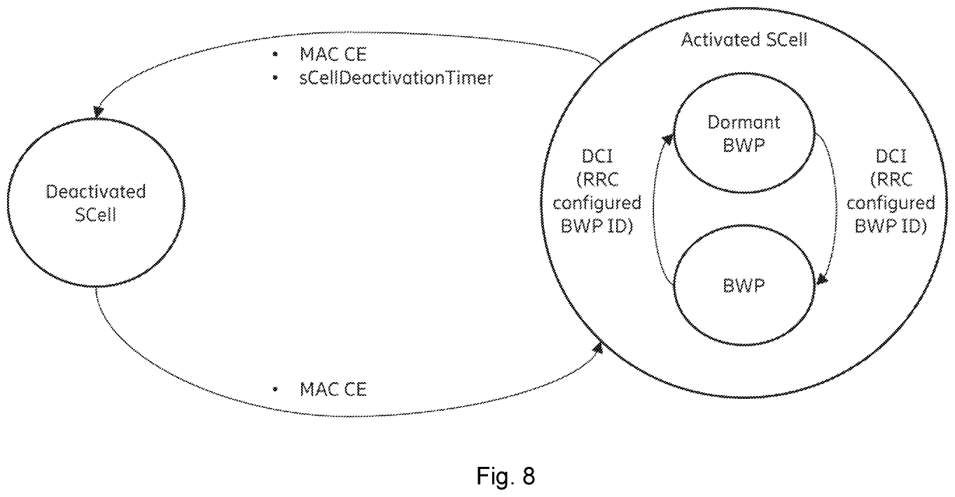

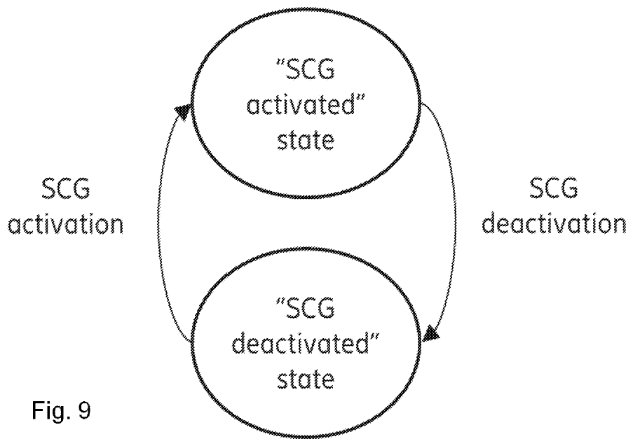

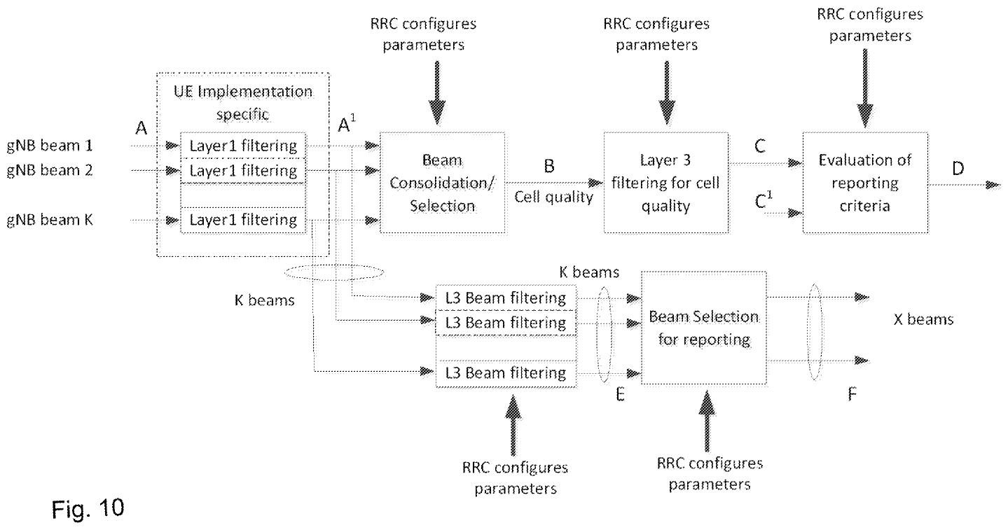

### DETAILED DESCRIPTION

As described above, certain challenges currently exist with multiple-radio dual connectivity (MR-DC) and measurement configuration for a deactivated secondary cell group (SCG). Certain aspects of the present disclosure and their embodiments may provide solutions to these or other challenges. Particular embodiments include methods for configuring and performing measurements for deactivated SCG mode of operation.

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

The terms suspended SCG, SCG in power saving mode, SCG deactivated mode of operation or deactivated SCG are used interchangeably. The term suspended SCG may also be referred to as deactivated SCG or inactive SCG, or dormant SCG.

The terms resumed SCG, SCG in normal operating mode and SCG in non-power saving mode are used interchangeably. The terms resumed SCG may also be referred to as activated SCG or active SCG. The operation of the SCG operating in resumed or active mode may also be referred to as normal SCG operation or legacy SCG operation. Examples of operations are UE signal reception/transmission procedures, e.g., reception of signals/messages, transmission of signals/messages, etc.

The text mostly refers to and describes examples wherein the second cell group is a SCG for a user equipment (UE) configured with MR-DC (e.g., NR-DC or EN-DC).

The text describes terms like SCG and PSCell, as one of the cells associated with the SCG. These may be, for example, a PSCell as defined in new radio (NR) specifications (e.g., RRC TS 38.331), defined as a special cell (SpCell) of the SCG, or a primary SCG cell (PSCell), as follows:
Secondary Cell Group: For a UE configured with dual connectivity, the subset of serving cells comprising the PSCell and zero or more secondary cells (SCells).
Special Cell: For dual connectivity operation, the term special cell refers to the PCell of the master cell group (MCG) or the PSCell of the SCG, otherwise the term special cell refers to the PCell.
Primary SCG Cell (PSCell): For dual connectivity operation, the SCG cell in which the UE performs random access when performing the Reconfiguration with Sync procedure.

For the sake of brevity, the text mostly refers to and describes examples wherein the second cell group is a SCG that is deactivated (or suspended or in power saving mode of operation), for a UE configured with, e.g., MR-DC. However, the method is equally applicable for the case where the second cell group is a MCG for a UE configured with dual connectivity (e.g., MR-DC), wherein the MCG may be suspended, while the SCG is operating in normal mode.

The text describes that when the second cell group is deactivated (e.g., SCG becomes deactivated upon reception of an indication from the network) the UE stops monitoring the physical downlink control channel (PDCCH) on the SCG cells (i.e., stops monitoring PDCCH of the PSCell and of the SCells of the SCG). Some embodiments are described using, as an example, a second cell group that is a SCG the UE configured with MR-DC is configured with; and, the SCG being deactivated mode of operation at the UE when the UE performs the actions disclosed in the method. However, the method is also applicable where the second cell group is a MCG that is deactivated, so that the UE stops monitoring PDCCH on the MCG and continues monitoring PDCCH on the SCG.

A first group of embodiments include a fixed measurement configuration subset for a deactivated SCG. In some embodiments, the UE measurements to perform, and/or measurement reporting to perform, when in deactivated SCG mode of operation, are a fixed subset of the configured measurements, for example a subset of the SN-configured measurements. This guarantees to the UE that a limited set of measurements are to be performed when the SCG is deactivated. Also, no signaling is required between the network and the UE when the SCG is activated or deactivated, because the UE already knows which measurements to perform when the SCG is deactivated (the fixed measurements) and which measurements to perform when the SCG is activated (the legacy, configured measurements).

Examples of measurements that the UE may be required to measure when the SCG is deactivated are: PSCell measurements (only), neighboring cells on the PSCell frequency, SCells, SCell neighbors on the SCell frequency, inter-frequency neighbors, and inter-RAT measurements.

The subset of measurements that the UE then may be configured to perform when the SCG is deactivated, based on e.g. the fixed configuration, may be any combination of these. This may, e.g., consist of the UE performing measurements on only the PSCell or the UE performs measurements on the PSCell, on neighboring cells on the PSCell frequency, and on inter-frequency neighbors.

When in SCG deactivated operation, the UE performs measurements and measurement reporting according to the fixed subset of the measurement configuration.

Some embodiments include a configured subset of measurements. For example, in some embodiments the measurements to be performed, and/or the measurement reporting, when the SCG is deactivated are configured explicitly. This may, e.g., be done by including an indication in RRCReconfiguration when configuring the measurements, indicating whether the measurements are applicable for deactivated SCG. The indication may, e.g., be set to TRUE if the measurement is applicable also for deactivated SCG. In another option, the indication may have different values, e.g., indicating whether it is applicable for deactivated SCG, for activated SCG or both activated and deactivated SCG. Absence of the indication may have a defined meaning, e.g., that the measurements are applicable independently of the SCG mode of operation.

The indication may, in one example, be defined together with the measurements in measConfig. An advantage of these embodiments is that it is flexible, and the network may configure the desired measurements also for deactivated SCG. These embodiments may also be combined with previous embodiments, where the fixed measurements are a minimum subset of measurements and where the network may also configure more measurements. It may be defined or indicated whether the configured measurements are in addition to the fixed measurements, or whether the configured measurements are replacing the fixed measurements.

In an example implementation, an indication is included for each measurement object, whether the measurement object is relevant for deactivated SCG or not. Example in TS 38.331:

The IE MeasObjectNR specifies information applicable for SS/PBCH block(s) intra/inter-frequency measurements and/or CSI-RS intra/inter-frequency measurements.

MeasObjectNR information element

-- ASN1START
-- TAG-MEASOBJECTNR-START

| | |
|---|---|
| MeasObjectNR ::= | SEQUENCE { |
| ssbFrequency | ARFCN-ValueNR |

OPTIONAL, -- Cond SSBorAssociatedSSB

| | |
|---|---|
| ssbSubcarrierSpacing | SubcarrierSpacing |

OPTIONAL, -- Cond SSBorAssociatedSSB

| | |
|---|---|
| smtc1 | SSB-MTC |

OPTIONAL, -- Cond SSBorAssociatedSSB

| | |
|---|---|
| smtc2 | SSB-MTC2 |

OPTIONAL, -- Cond IntraFreqConnected

| | |
|---|---|
| refFreqCSI-RS | ARFCN-ValueNR |

OPTIONAL, -- Cond CSI-RS

| | |
|---|---|
| referenceSignalConfig | ReferenceSignalConfig, |
| absThreshSS-BlocksConsolidation | ThresholdNR |

OPTIONAL, -- Need R

| | |
|---|---|
| absThreshCSI-RS-Consolidation | ThresholdNR |

OPTIONAL, -- Need R

| | |
|---|---|
| nrofSS-BlocksToAverage | INTEGER (2..maxNrofSS-BlocksToAverage) |

OPTIONAL, -- Need R

| | |
|---|---|
| nrofCSI-RS-ResourcesToAverage | INTEGER (2..maxNrofCSI-RS-ResourcesToAverage) |

OPTIONAL, -- Need R

| | |
|---|---|
| quantityConfigIndex | INTEGER (1..maxNrofQuantityConfig), |
| offsetMO | Q-OffsetRangeList, |
| cellsToRemoveList | PCI-List |

OPTIONAL, -- Need N

| | |
|---|---|
| cellsToAddModList | CellsToAddModList |

OPTIONAL, -- Need N

| | |
|---|---|
| blackCellsToRemoveList | PCI-RangeIndexList |

OPTIONAL, -- Need N

| | |
|---|---|
| blackCellsToAddModList | SEQUENCE (SIZE (1..maxNrofPCI-Ranges)) OF PCI- |

RangeElement OPTIONAL, -- Need N

| | |
|---|---|
| whiteCellsToRemoveList | PCI-RangeIndexList |

OPTIONAL, -- Need N

| | |
|---|---|
| whiteCellsToAddModList | SEQUENCE (SIZE (1..maxNrofPCI-Ranges)) OF PCI- |

```
RangeElement OPTIONAL, -- Need N
  ...,
  [[
```

| | |
|---|---|
| freqBandIndicatorNR | FreqBandIndicatorNR |

OPTIONAL, -- Need R

| | |
|---|---|
| measCycleSCell | ENUMERATED {sf160, sf256, sf320, sf512, sf640, sf1024, |

```
sf1280} OPTIONAL -- Need R
  ]],
  [[
```

| | |
|---|---|
| smtc3list-r16 | SSB-MTC3List-r16 |

OPTIONAL, -- Need R

| | |
|---|---|
| rmtc-Config-r16 | SetupRelease {RMTC-Config-r16} |

OPTIONAL, -- Need M

| | |
|---|---|
| t312-r16 | SetupRelease { T312-r16 } |

```
OPTIONAL -- Need M
  ]],
  [[
```

| | |
|---|---|
| measDeactivatedSCG | ENUMERATED {deact, act, both} |

]]
}

| | |
|---|---|
| SSB-MTC3List-r16::= | SEQUENCE (SIZE(1..4)) OF SSB-MTC3-r16 |
| T312-r16 ::= | ENUMERATED { ms0, ms50, ms100, ms200, ms300, ms400, ms500, |

ms1000}

| | |
|---|---|
| ReferenceSignalConfig::= | SEQUENCE { |
| ssb-ConfigMobility | SSB-ConfigMobility |

OPTIONAL, -- Need M

| | |
|---|---|
| csi-rs-ResourceConfigMobility | SetupRelease { CSI-RS-ResourceConfigMobility } |

OPTIONAL -- Need M
}

| | |
|---|---|
| SSB-ConfigMobility::= | SEQUENCE { |

| | |
|---|---|
| ssb-ToMeasure | SetupRelease { SSB-ToMeasure } |

OPTIONAL, -- Need M

| | |
|---|---|
| deriveSSB-IndexFromCell | BOOLEAN, |

| | |
|---|---|
| ss-RSSI-Measurement | SS-RSSI-Measurement |

```
OPTIONAL, -- Need M
  ...,
  [[
```

| | |
|---|---|
| ssb-PositionQCL-Common-r16 | SSB-PositionQCL-Relation-r16 |

OPTIONAL, -- Cond SharedSpectrum

| | |
|---|---|
| ssb-PositionQCL-CellsToAddModList-r16 | SSB-PositionQCL-CellsToAddModList-r16 |

OPTIONAL, -- Need N

| | |
|---|---|
| ssb-PositionQCL-CellsToRemoveList-r16 | PCI-List |

OPTIONAL -- Need N
]]
}

| Q-OffsetRangeList ::= | SEQUENCE { | |
|---|---|---|
| rsrpOffsetSSB | Q-OffsetRange | DEFAULT dB0, |
| rsrqOffsetSSB | Q-OffsetRange | DEFAULT dB0, |
| sinrOffsetSSB | Q-OffsetRange | DEFAULT dB0, |
| rsrpOffsetCSI-RS | Q-OffsetRange | DEFAULT dB0, |
| rsrqOffsetCSI-RS | Q-OffsetRange | DEFAULT dB0, |
| sinrOffsetCSI-RS | Q-OffsetRange | DEFAULT dB0 |

}

| | |
|---|---|
| ThresholdNR ::= | SEQUENCE{ |
| thresholdRSRP | RSRP-Range |

OPTIONAL, -- Need R

| | |
|---|---|
| thresholdRSRQ | RSRQ-Range |

OPTIONAL, -- Need R

| | |
|---|---|
| thresholdSINR | SINR-Range |

OPTIONAL -- Need R
}

| | |
|---|---|
| CellsToAddModList ::= | SEQUENCE (SIZE (1..maxNrofCellMeas)) OF CellsToAddMod |
| CellsToAddMod ::= | SEQUENCE { |
| physCellId | PhysCellId, |
| cellIndividualOffset | Q-OffsetRangeList |

}

| | |
|---|---|
| RMTC-Config-r16 ::= | SEQUENCE { |
| rmtc-Periodicity-r16 | ENUMERATED {ms40, ms80, ms160, ms320, ms640}, |
| rmtc-SubframeOffset-r16 | INTEGER (0..639) |

OPTIONAL, -- Need M

| | |
|---|---|
| measDurationSymbols-r16 | ENUMERATED {sym1, sym14or12, sym28or24, sym42or36, |

sym70or60},

| | |
|---|---|
| rmtc-Frequency-r16 | ARFCN-ValueNR, |
| ref-SCS-CP-r16 | ENUMERATED {kHz15, kHz30, kHz60-NCP, kHz60-ECP}, |

...
}
SSB-PositionQCL-CellsToAddModList-r16 ::= SEQUENCE (SIZE (1..maxNrofCellMeas)) OF SSB-
PositionQCL-CellsToAddMod-r16
SSB-PositionQCL-CellsToAddMod-r16 ::= SEQUENCE {

| | |
|---|---|
| physCellId-r16 | PhysCellId, |
| ssb-PositionQCL-r16 | SSB-PositionQCL-Relation-r16 |

}
-- TAG-MEASOBJECTNR-STOP
-- ASN1STOP

CellsToAddMod field descriptions

cellIndividualOffset
Cell individual offsets applicable to a specific cell.
physCellId
Physical cell identity of a cell in the cell list.

MeasObjectNR field descriptions

absThreshCSI-RS-Consolidation
Absolute threshold for the consolidation of measurement results per CSI-RS resource(s)
from L1 filter(s). The field is used for the derivation of cell measurement results as
described in 5.5.3.3 and the reporting of beam measurement information per CSI-RS
resource as described in 5.5.5.2.
absThreshSS-BlocksConsolidation
Absolute threshold for the consolidation of measurement results per SS/PBCH block(s)
from L1 filter(s). The field is used for the derivation of cell measurement results as
described in 5.5.3.3 and the reporting of beam measurement information per SS/PBCH
block index as described in 5.5.5.2.
blackCellsToAddModList
List of cells to add/modify in the black list of cells. It applies only to SSB resources.
blackCellsToRemoveList
List of cells to remove from the black list of cells.
cellsToAddModList
List of cells to add/modify in the cell list.
cellsToRemoveList
List of cells to remove from the cell list.
freqBandIndicatorNR
The frequency band in which the SSB and/or CSI-RS indicated in this MeasObjectNR are
located and according to which the UE shall perform the RRM measurements. This field is
always provided when the network configures measurements with this MeasObjectNR.
measCycleSCell
The parameter is used only when an SCell is configured on the frequency indicated by the
measObjectNR and is in deactivated state, see TS 38.133. gNB configures the parameter
whenever an SCell is configured on the frequency indicated by the measObjectNR, but the
field may also be signalled when an SCell is not configured. Value sf160 corresponds to
160 sub-frames, value sf256 corresponds to 256 sub-frames and so on.
measDeactivatedSCG
The parameter is used to indicate whether the measurements are applicable only when the
SCG is in deactivated mode of operation, when in activated mode of operation or when in
both activated and deactivated mode of operation. Absence of the field indicates that the
measurement is applicable for activated SCG mode of operation.
nrofCSInrofCSI-RS-ResourcesToAverage
Indicates the maximum number of measurement results per beam based on CSI-RS
resources to be averaged. The same value applies for each detected cell associated with this
MeasObjectNR.
nrofSS-BlocksToAverage
Indicates the maximum number of measurement results per beam based on SS/PBCH
blocks to be averaged. The same value applies for each detected cell associated with this
MeasObject.
offsetMO
Offset values applicable to all measured cells with reference signal(s) indicated in this
MeasObjectNR.
quantityConfigIndex
Indicates the n-th element of quantityConfigNR-List provided in MeasConfig.
referenceSignalConfig
RS configuration for SS/PBCH block and CSI-RS.
refFreqCSI-RS
Point A which is used for mapping of CSI-RS to physical resources according to TS 38.211
clause 7.4.1.5.3.
smtc1
Primary measurement timing configuration. (see clause 5.5.2.10).
smtc2
Secondary measurement timing configuration for SS corresponding to this MeasObjectNR
with PCI listed in pci-List. For these SS, the periodicity is indicated by periodicity in smtc2
and the timing offset is equal to the offset indicated in periodicityAndOffset modulo
periodicity. periodicity in smtc2 can only be set to a value strictly shorter than the
periodicity indicated by periodicityAndOffset in smtc1 (e.g. if periodicityAndOffset
indicates sf10, periodicity can only be set of sf5, if periodicityAndOffset indicates sf5, smtc2
cannot be configured).
smtc3list
Measurement timing configuration list for SS corresponding to IAB-MT. This is used for
the IAB-node's discovery of other IAB-nodes and the IAB-Donor-DUs.
ssbFrequency
Indicates the frequency of the SS associated to this MeasObjectNR. For operation with
shared spectrum channel access, this field is a k*30 kHz shift from the sync raster where
k = 0, 1, 2, and so on if the reportType within the corresponding ReportConfigNR is set to
reportCGI (see TS 38.211, clause 7.4.3.1). Frequencies are considered to be on the sync
raster if they are also identifiable with a GSCN value (see TS 38.101-1).
ssb-PositionQCL-Common
Indicates the QCL relationship between SS/PBCH blocks for all measured cells as specified
in TS 38.213, clause 4.1.
ssbSubcarrierSpacing
Subcarrier spacing of SSB. Only the values 15 kHz or 30 kHz (FR1), and 120 kHz or 240
kHz (FR2) are applicable.
t312
The value of timer T312. Value ms0 represents 0 ms, ms50 represents 50 ms and so on.
whiteCellsToAddModList
List of cells to add/modify in the white list of cells. It applies only to SSB resources.
whiteCellsToRemoveList
List of cells to remove from the white list of cells.

RMTC-Config field descriptions

measDurationSymbols
Number of consecutive symbols for which the Physical Layer reports samples of RSSI (see
TS 38.215, clause 5.1.21). Value sym1 corresponds to one symbol, sym14or12 corresponds
to 14 symbols of the reference numerology for NCP and 12 symbols for ECP, and so on.
ref-SCS-CP
Indicates a reference subcarrier spacing and cyclic prefix to be used for RSSI measurements
(see TS 38.215). Value kHz15 corresponds to 15 kHz, kHz30 corresponds to 30 kHz, value
kHz60-NCP corresponds to 60 kHz using normal cyclic prefix (NCP), and kHz60-ECP
corresponds to 60 kHz using extended cyclic prefix (ECP).
rmtc-Frequency
Indicates the center frequency of the measured bandwidth (see TS 38. 215, clause 5.1.21).
rmtc-Periodicity
Indicates the RSSI measurement timing configuration (RMTC) periodicity (see TS 38.215,
clause 5.1.21).
rmtc-SubframeOffset
Indicates the RSSI measurement timing configuration (RMTC) subframe offset for this
frequency (see TS 38.215, clause 5.1.21). For inter-frequency measurements, this field is
optional present and if it is not configured, the UE chooses a random value as rmtc-
SubframeOffset for measDurationSymbols which shall be selected to be between 0 and the
configured rmtc-Periodicity with equal probability.

ReferenceSignalConfig field descriptions

csi-rs-ResourceConfigMobility
CSI-RS resources to be used for CSI-RS based RRM measurements.
ssb-ConfigMobility
SSB configuration for mobility (nominal SSBs, timing configuration).

SSB-ConfigMobility field descriptions

deriveSSB-IndexFromCell
If this field is set to true, UE assumes SFN and frame boundary alignment across cells on
the same frequency carrier as specified in TS 38.133. Hence, if the UE is configured with a
serving cell for which (absoluteFrequencySSB, subcarrierSpacing) in
ServingCellConfigCommon is equal to (ssbFrequency, ssbSubcarrierSpacing) in this
MeasObjectNR, this field indicates whether the UE can utilize the timing of this serving cell
to derive the index of SS block transmitted by neighbour cell. Otherwise, this field indicates
whether the UE may use the timing of any detected cell on that target frequency to derive
the SSB index of all neighbour cells on that frequency.
ssb-ToMeasure
The set of SS blocks to be measured within the SMTC measurement duration. The
first/leftmost bit corresponds to SS/PBCH block index 0, the second bit corresponds to
SS/PBCH block index 1, and so on. Value 0 in the bitmap indicates that the corresponding
SS/PBCH block is not to be measured while value 1 indicates that the corresponding
SS/PBCH block is to be measured (see TS 38.215). When the field is not configured the UE
measures on all SS blocks. Regardless of the value of this field, SS/PBCH blocks outside of
the applicable smtc are not to be measured. See TS 38.215 clause 5.1.1.

SSB-PositionQCL-CellsToAddMod field descriptions

physCellId
Physical cell identity of a cell in the cell list.
ssb-PositionQCL
Indicates the QCL relationship between SS/PBCH blocks for a specific cell
as specified in TS 38.213, clause 4.1. If provided, the cell specific
value overwrites the value signalled by ssb-PositionQCL-Common.

| Conditional Presence | Explanation |
|---|---|
| CSI-RS | This field is mandatory present if csi-rs- |
| | ResourceConfigMobility is configured, otherwise, |
| | it is absent. |
| SSBorAssociatedSSB | This field is mandatory present if ssb- |
| | ConfigMobility is configured or associatedSSB is |
| | configured in at least one cell. Otherwise, it is |
| | absent, Need R. |
| IntraFreqConnected | This field is optionally present, Need R if the UE |
| | is configured with a serving cell for which |
| | (absoluteFrequencySSB, subcarrierSpacing) in |
| | ServingCellConfigCommon is equal to |
| | (ssbFrequency, ssbSubcarrierSpacing) in this |
| | MeasObjectNR, otherwise, it is absent. |
| SharedSpectrum | This field is mandatory present if this MeasObject |
| | is for a frequency which operates with shared |
| | spectrum channel access. Otherwise, it is absent, |
| | Need R. |

In some embodiments, one or some of the measurements in the subset to be performed when the SCG is deactivated is/are associated with a criterion or a condition. In some embodiments, the UE determines whether to perform a specific measurement (when the SCG is deactivated) depending on if the associated criterion for the measurement is valid or not.

In one example, the criterion is a reference to another measurement, where the results of that measurement may trigger whether the UE starts or stops performing the measurement for which the criterion is configured (when the SCG is deactivated). For example, when the SCG is deactivated, if e.g. the signal strength of the (deactivated) PSCell becomes below a specific threshold, the UE starts performing measurements on neighboring cells on the PSCell frequency and/or on inter-frequency neighbors for the PSCell. On the other hand, if the signal strength of the (deactivated) PSCell becomes above another threshold, the UE stops performing those measurements.

Different measurements may then be configured with different threshold values. The configuration may be performed in a similar way as described above, i.e., that one or more threshold(s) are included together with the explicit indication, which is e.g. defined together with the measurements in measConfig. The threshold value(s) may then be related to another measurement and, e.g., indicate when the UE should start or stop performing the measurement for which it is included.

A second group of embodiments includes differentiated relaxed measurement cycles. For example, in some embodiments, which can be combined with any of the other embodiments above, when in deactivated SCG mode of operation, the UE performs measurements according to the measurement configuration (or a potential subset of the measurement configuration), but uses different relaxed measurement cycles for different measurement objects (e.g., frequencies). In these embodiments, the obtained measurement cycle configuration contains the different relaxed measurement cycles.

Some embodiments include different relaxed measurement cycles for PSCell and SCell frequencies. For example, in some embodiments, for measurements on the SCell frequencies, the UE is configured with a relaxed measurement cycle, measCycleSCell. The UE performs measurements on the SCell frequencies according the measCycleSCell when the SCG is deactivated (in deactivated SCG mode of operation) or the SCell is deactivated.

Further, for measurements on the PSCell frequency, the UE is configured with another relaxed measurement cycle, defined as measCyclePSCell. The UE performs measurements on the SCell frequencies according the measCyclePSCell when the SCG is deactivated. In this variant, for use when the SCG is deactivated, the UE thus can be configured with different measurement cycles for the SCell and PSCell frequencies. For example, the network may configure the UE with a measCycleSCell of 640 subframes and a measCyclePSCell of 320 subframes. This means that when the SCG is deactivated, the UE measurement cycle for measurements on the PSCell frequency is shorter than for the SCell frequency.

The measCycleSCell and measCyclePSCell are both associated with the SCG and configured in the UE by the SN included in the RRCReconfiguration message received via SRB3, or, alternatively, included within a RRCReconfiguration message embedded in a RRCReconfiguration message received via SRB1, or alternatively included within an RRCReconfiguration message embedded in a RRCConnectionReconfiguration message received via E-UTRA.

Below is an example implementation in the RRC specification TS 38.331 for these embodiments (some parts not shown).

The IE MeasObjectNR specifies information applicable for SS/PBCH block(s) intra/inter-frequency measurements and/or CSI-RS intra/inter-frequency measurements.

MeasObjectNR information element

-- ASN1START
-- TAG-MEASOBJECTNR-START

| | |
|---|---|
| MeasObjectNR ::= | SEQUENCE { |
| ssbFrequency | ARFCN-ValueNR |

OPTIONAL, -- Cond SSBorAssociatedSSB

| | |
|---|---|
| ssbSubcarrierSpacing | SubcarrierSpacing |

OPTIONAL, -- Cond SSBorAssociatedSSB

| | |
|---|---|
| smtc1 | SSB-MTC |

OPTIONAL, -- Cond SSBorAssociatedSSB

| | |
|---|---|
| smtc2 | SSB-MTC2 |

OPTIONAL, -- Cond IntraFreqConnected

| | |
|---|---|
| refFreqCSI-RS | ARFCN-ValueNR |

OPTIONAL, -- Cond CSI-RS

| | |
|---|---|
| referenceSignalConfig | ReferenceSignalConfig, |
| absThreshSS-BlocksConsolidation | ThresholdNR |

OPTIONAL, -- Need R

| | |
|---|---|
| absThreshCSI-RS-Consolidation | ThresholdNR |

OPTIONAL, -- Need R

| | |
|---|---|
| nrofSS-BlocksToAverage | INTEGER (2..maxNrofSS-BlocksToAverage) |

OPTIONAL, -- Need R

| | |
|---|---|
| nrofCSI-RS-ResourcesToAverage | INTEGER (2..maxNrofCSI-RS-ResourcesToAverage) |

OPTIONAL, -- Need R

| | |
|---|---|
| quantityConfigIndex | INTEGER (1..maxNrofQuantityConfig), |
| offsetMO | Q-OffsetRangeList, |
| cellsToRemoveList | PCI-List |

OPTIONAL, -- Need N

| | |
|---|---|
| cellsToAddModList | CellsToAddModList |

OPTIONAL, -- Need N

| | |
|---|---|
| blackCellsToRemoveList | PCI-RangeIndexList |

OPTIONAL, -- Need N

| | |
|---|---|
| blackCellsToAddModList | SEQUENCE (SIZE (1..maxNrofPCI-Ranges)) OF PCI- |

RangeElement OPTIONAL, -- Need N

| | |
|---|---|
| whiteCellsToRemoveList | PCI-RangeIndexList |

OPTIONAL, -- Need N

| | |
|---|---|
| whiteCellsToAddModList | SEQUENCE (SIZE (1..maxNrofPCI-Ranges)) OF PCI- |

```
RangeElement OPTIONAL, -- Need N
  ...,
  [[
```

| | |
|---|---|
| freqBandIndicatorNR | FreqBandIndicatorNR |

OPTIONAL, -- Need R

| | |
|---|---|
| measCycleSCell | ENUMERATED {sf160, sf256, sf320, sf512, sf640, sf1024, |

```
sf1280} OPTIONAL -- Need R
  ]],
  [[
```

| | |
|---|---|
| smtc3list-r16 | SSB-MTC3List-r16 |

OPTIONAL, -- Need R

| | |
|---|---|
| rmtc-Config-r16 | SetupRelease {RMTC-Config-r16} |

OPTIONAL, -- Need M

| | |
|---|---|
| t312-r16 | SetupRelease { T312-r16 } |

```
OPTIONAL -- Need M
  ]],
  [[
```

| | |
|---|---|
| measCyclePSCell | ENUMERATED {sf160, sf256, sf320, sf512, sf640, sf1024, |

sf1280} OPTIONAL -- Need R
]]
}
-- TAG-MEASOBJECTNR-STOP
-- ASN1STOP

MeasObjectNR field descriptions

measCycleSCell
The parameter is used only when an SCell is configured on the frequency indicated by the
measObjectNR and is in deactivated state, see TS 38.133, or when the SCG is in deactivated
state. gNB configures the parameter whenever an SCell is configured on the frequency
indicated by the measObjectNR, but the field may also be signalled when an SCell is not
configured. Value sf160 corresponds to 160 sub-frames, value sf256 corresponds to 256 sub-
frames and so on.
measCyclePSCell
The parameter is used only when a PSCell is configured on the frequency indicated by the
measObjectNR and when the SCG is in deactivated state. gNB configures the parameter
whenever a PSCell is configured on the frequency indicated by the measObjectNR. Value
sf160 corresponds to 160 sub-frames, value sf256 corresponds to 256 sub-frames and so on.

Some embodiments include different relaxed measurement cycles for PSCell, SCell and other frequencies. In some embodiments, the UE is configured with a relaxed measurement cycle, measCycleSCell. The UE performs measurements on the SCell frequencies according the measCycleSCell when the SCG is deactivated (in deactivated SCG mode of operation) or the SCell is deactivated.

Further, for measurements on the PSCell frequency, the UE is configured with another relaxed measurement cycle, defined as measCyclePSCell. The UE performs measurements on the PSCell frequencies according the measCyclePSCell when the SCG is deactivated. Further, for other measurements, including measurements on other than the PSCell or SCells frequencies, the UE is configured with yet another relaxed measurement cycle, defined as measCycleOther. The UE performs measurements on other frequencies, including other frequencies than the PSCell or SCells frequencies, according the measCycleOther when the SCG is deactivated.

In these embodiments, for use when the SCG is deactivated, the UE thus may be configured with different measurement cycles for the SCell, PSCell and other frequencies. For example, the network may configure a UE with a measCycleSCell of 640 subframes, a measCyclePSCell of 320 subframes and a measCycleOther of 1280 subframes. This means that when the SCG is deactivated, the UE measurement cycle for measurements on the PSCell frequency is shorter than for the SCell frequency which in turn is shorter than measurements on other frequencies.

The measCycleSCell, measCyclePSCell and measCycleOther are all associated with the SCG and configured in the UE by the SN included in the RRCReconfiguration message received via SRB3, or, alternatively, included within a RRCReconfiguration message embedded in a RRCReconfiguration message received via SRB1, or alternatively included within an RRCReconfiguration message embedded in a RRCConnectionReconfiguration message received via E-UTRA.

Below is an example implementation in the RRC specification TS 38.331 for these embodiments (some parts not shown).

The IE MeasObjectNR specifies information applicable for SS/PBCH block(s) intra/inter-frequency measurements and/or CSI-RS intra/inter-frequency measurements.

MeasObjectNR information element

-- ASN1START
-- TAG-MEASOBJECTNR-START

| | |
|---|---|
| MeasObjectNR ::= | SEQUENCE { |
| ssbFrequency | ARFCN-ValueNR |

OPTIONAL, -- Cond SSBorAssociatedSSB

| | |
|---|---|
| ssbSubcarrierSpacing | SubcarrierSpacing |

OPTIONAL, -- Cond SSBorAssociatedSSB

| | |
|---|---|
| smtc1 | SSB-MTC |

OPTIONAL, -- Cond SSBorAssociatedSSB

| | |
|---|---|
| smtc2 | SSB-MTC2 |

OPTIONAL, -- Cond IntraFreqConnected

| | |
|---|---|
| refFreqCSI-RS | ARFCN-ValueNR |

OPTIONAL, -- Cond CSI-RS

| | |
|---|---|
| referenceSignalConfig | ReferenceSignalConfig, |
| absThreshSS-BlocksConsolidation | ThresholdNR |

OPTIONAL, -- Need R

| | |
|---|---|
| absThreshCSI-RS-Consolidation | ThresholdNR |

OPTIONAL, -- Need R

| | |
|---|---|
| nrofSS-BlocksToAverage | INTEGER (2..maxNrofSS-BlocksToAverage) |

OPTIONAL, -- Need R

| | |
|---|---|
| nrofCSI-RS-ResourcesToAverage | INTEGER (2..maxNrofCSI-RS-ResourcesToAverage) |

OPTIONAL, -- Need R

| | |
|---|---|
| quantityConfigIndex | INTEGER (1..maxNrofQuantityConfig), |
| offsetMO | Q-OffsetRangeList, |
| cellsToRemoveList | PCI-List |

OPTIONAL, -- Need N

| | |
|---|---|
| cellsToAddModList | CellsToAddModList |

OPTIONAL, -- Need N

| | |
|---|---|
| blackCellsToRemoveList | PCI-RangeIndexList |

OPTIONAL, -- Need N

| | |
|---|---|
| blackCellsToAddModList | SEQUENCE (SIZE (1..maxNrofPCI-Ranges)) OF PCI- |

RangeElement OPTIONAL, -- Need N

| | |
|---|---|
| whiteCellsToRemoveList | PCI-RangeIndexList |

OPTIONAL, -- Need N

| | |
|---|---|
| whiteCellsToAddModList | SEQUENCE (SIZE (1..maxNrofPCI-Ranges)) OF PCI- |

```
RangeElement OPTIONAL, -- Need N
  ...,
  [[
```

| | |
|---|---|
| freqBandIndicatorNR | FreqBandIndicatorNR |

OPTIONAL, -- Need R

| | |
|---|---|
| measCycleSCell | ENUMERATED {sf160, sf256, sf320, sf512, sf640, sf1024, |

```
sf1280} OPTIONAL -- Need R
  ]],
  [[
```

| | |
|---|---|
| smtc3list-r16 | SSB-MTC3List-r16 |

OPTIONAL, -- Need R

| | |
|---|---|
| rmtc-Config-r16 | SetupRelease {RMTC-Config-r16} |

OPTIONAL, -- Need M

| | |
|---|---|
| t312-r16 | SetupRelease { T312-r16 } |

```
OPTIONAL -- Need M
  ]],
  [[
```

| | |
|---|---|
| measCyclePSCell | ENUMERATED {sf160, sf256, sf320, sf512, sf640, sf1024, |

sf1280} OPTIONAL, -- Need R

| | |
|---|---|
| measCycleOther | ENUMERATED {sf160, sf256, sf320, sf512, sf640, sf1024, |

sf1280} OPTIONAL -- Need R
]]
}
-- TAG-MEASOBJECTNR-STOP
-- ASN1STOP

MeasObjectNR field descriptions

measCycleSCell
The parameter is used only when an SCell is configured on the frequency indicated by the
measObjectNR and is in deactivated state, see TS 38.133, or when the SCG is in deactivated
state. gNB configures the parameter whenever an SCell is configured on the frequency
indicated by the measObjectNR, but the field may also be signalled when an SCell is not
configured. Value sf160 corresponds to 160 sub-frames, value sf256 corresponds to 256 sub-
frames and so on.
measCyclePSCell
The parameter is used only when a PSCell is configured on the frequency indicated by the
measObjectNR and when the SCG is in deactivated state. gNB configures the parameter
whenever a PSCell is configured on the frequency indicated by the measObjectNR. Value
sf160 corresponds to 160 sub-frames, value sf256 corresponds to 256 sub-frames and so on.
measCycleOther
The parameter is used only when neither a PSCell nor an SCell is configured on the
frequency indicated by the measObjectNR and when the SCG is in deactivated state. Value
sf160 corresponds to 160 sub-frames, value sf256 corresponds to 256 sub-frames and so on.

Some embodiments include a default relaxed measurement cycle for all SN-configured measurements when SCG is deactivated. For example, in some embodiments, the UE is configured with a default relaxed measurement cycle, defined as measCycleDeactivatedSCG to be used when the SCG is deactivated (in deactivated SCG mode of operation). In one example, the measurement cycle configured by measCycleDeactivatedSCG is used for all SN-configured measurements when the SCG is deactivated, i.e., the PSCell frequency measurements (PSCell and neighbors on the same frequency as the PSCell), SCell frequency measurements (SCells and neighbors on the same frequency/frequencies as the SCells) and measurements on other frequencies. In one example, the default relaxed measurement cycle is also used for inter-RAT measurements (including measurements on long term evolution (LTE) frequencies).

In one example, the measCycleDeactivatedSCG is associated with the SCG and configured in the UE by the SN included in the RRCReconfiguration message received via SRB3, or, alternatively, included within a RRCReconfiguration message embedded in a RRCReconfiguration message received via SRB1, or alternatively included within an RRCReconfiguration message embedded in a RRCConnectionReconfiguration message received via E-UTRA.

Below is an example implementation in the RRC specification TS 38.331 for these embodiments (some parts not shown).

The IE MeasConfig specifies measurements to be performed by the UE, and covers intra-frequency, inter-frequency, and inter-RAT mobility as well as configuration of measurement gaps.

MeasConfig information element

-- ASN1START
-- TAG-MEASCONFIG-START

| | |
|---|---|
| MeasConfig ::= | SEQUENCE { |
| measObjectToRemoveList | MeasObjectToRemoveList |

OPTIONAL, -- Need N

| | |
|---|---|
| measObjectToAddModList | MeasObjectToAddModList |

OPTIONAL, -- Need N

| | |
|---|---|
| reportConfigToRemoveList | ReportConfigToRemoveList |

OPTIONAL, -- Need N

| | |
|---|---|
| reportConfigToAddModList | ReportConfigToAddModList |

OPTIONAL, -- Need N

| | |
|---|---|
| measIdToRemoveList | MeasIdToRemoveList |

OPTIONAL, -- Need N

| | |
|---|---|
| measIdToAddModList | MeasIdToAddModList |

OPTIONAL, -- Need N

| | |
|---|---|
| s-MeasureConfig | CHOICE { |
| ssb-RSRP | RSRP-Range, |
| csi-RSRP | RSRP-Range |

}
OPTIONAL, -- Need M

| | |
|---|---|
| quantityConfig | QuantityConfig |

OPTIONAL, -- Need M

| | |
|---|---|
| measGapConfig | MeasGapConfig |

OPTIONAL, -- Need M

| | |
|---|---|
| measGapSharingConfig | MeasGapSharingConfig |

```
OPTIONAL, -- Need M
  ...,
  [[
```

| | |
|---|---|
| interFrequencyConfig-NoGap-r16 | ENUMERATED {true} |

```
OPTIONAL -- Need R
  ]],
  [[
```

| | |
|---|---|
| measCycleDeactivatedSCG | ENUMERATED {sf160, sf256, sf320, sf512, sf640, |

sf1024, sf1280} OPTIONAL -- Need R
]]
}

| | |
|---|---|
| MeasObjectToRemoveList ::= | SEQUENCE (SIZE (1..maxNrofObjectId)) OF MeasObjectId |
| MeasIdToRemoveList ::= | SEQUENCE (SIZE (1..maxNrofMeasId)) OF MeasId |
| ReportConfigToRemoveList ::= | SEQUENCE (SIZE (1..maxReportConfigId)) OF |

ReportConfigId
-- TAG-MEASCONFIG-STOP
-- ASN1STOP

MeasConfig field descriptions

measCycleDeactivatedSCG
The parameter is used only when the SCG is in deactivated state.
Value sf160 corresponds to 160 sub-frames, value sf256 corresponds
to 256 sub-frames and so on.

Some embodiments include dynamic differentiation of measurement cycles. For example, in some embodiments, the UE is configured with a set of multiple relaxed measurement cycles for a measurement object or a set of measurements objects, e.g., the PSCell frequency, the SCell frequency, or some other frequency. Each of the multiple relaxed measurement cycles are associated with a criterion or a condition. In these embodiments, for measurements on the measurement object configured with such a set of multiple relaxed measurement cycles, the UE selects and applies a relaxed measurement cycle when the criterion associated with the measurement cycle is valid.

In one example, the set of multiple relaxed measurement cycles are used when the SCG is in deactivated SCG mode of operation. In another example, the set of multiple relaxed measurement cycles are used also when the SCG is not in deactivated SCG mode of operation, that is, when SCG is deactivated. In yet another example, the set of multiple relaxed measurement cycles are used also when the UE is not configured with MR-DC or as part of the MN-configured measurements.

In one example, the criterion is a reference to a measurement identity part of the reporting configuration (ReportConfigNR) and a new type of reporting, which triggers a measurement cycle switch, rather than (or in addition to) a measurement report is defined for this purpose. In this example, the criterion is fulfilled when a measurement event, such as event A3 (““Neighbor becomes offset better than PCell/PSCell”) or event A5 (“PCell/PSCell becomes worse than threshold1 and neighbor becomes better than threshold2”) is triggered. For example, the UE applies a measurement cycle (such as a relatively short measurement cycle) when event A5 is triggered.

The set of measurement cycles, defined in one example as measCycleDeactivatedSCG-List, is associated with the SCG and configured in the UE by the SN included in the RRCReconfiguration message received via SRB3, or, alternatively, included within a RRCReconfiguration message embedded in a RRCReconfiguration message received via SRB1, or alternatively included within an RRCReconfiguration message embedded in a RRCConnectionReconfiguration message received via E-UTRA.

Below is an example implementation in the RRC specification TS 38.331 for these embodiments (some parts not shown).

The IE MeasObjectNR specifies information applicable for SS/PBCH block(s) intra/inter-frequency measurements and/or CSI-RS intra/inter-frequency measurements.

MeasObjectNR information element

-- ASN1START
-- TAG-MEASOBJECTNR-START

| | |
|---|---|
| MeasObjectNR ::= | SEQUENCE { |
| ssbFrequency | ARFCN-ValueNR |

OPTIONAL, -- Cond SSBorAssociatedSSB

| | |
|---|---|
| ssbSubcarrierSpacing | SubcarrierSpacing |

OPTIONAL, -- Cond SSBorAssociatedSSB

| | |
|---|---|
| smtc1 | SSB-MTC |

OPTIONAL, -- Cond SSBorAssociatedSSB

| | |
|---|---|
| smtc2 | SSB-MTC2 |

OPTIONAL, -- Cond IntraFreqConnected

| | |
|---|---|
| refFreqCSI-RS | ARFCN-ValueNR |

OPTIONAL, -- Cond CSI-RS

| | |
|---|---|
| referenceSignalConfig | ReferenceSignalConfig, |
| absThreshSS-BlocksConsolidation | ThresholdNR |

OPTIONAL, -- Need R

| | |
|---|---|
| absThreshCSI-RS-Consolidation | ThresholdNR |

OPTIONAL, -- Need R

| | |
|---|---|
| nrofSS-BlocksToAverage | INTEGER (2..maxNrofSS-BlocksToAverage) |

OPTIONAL, -- Need R

| | |
|---|---|
| nrofCSI-RS-ResourcesToAverage | INTEGER (2..maxNrofCSI-RS-ResourcesToAverage) |

OPTIONAL, -- Need R

| | |
|---|---|
| quantityConfigIndex | INTEGER (1..maxNrofQuantityConfig), |
| offsetMO | Q-OffsetRangeList, |
| cellsToRemoveList | PCI-List |

OPTIONAL, -- Need N

| | |
|---|---|
| cellsToAddModList | CellsToAddModList |

OPTIONAL, -- Need N

| | |
|---|---|
| blackCellsToRemoveList | PCI-RangeIndexList |

OPTIONAL, -- Need N

| | |
|---|---|
| blackCellsToAddModList | SEQUENCE (SIZE (1..maxNrofPCI-Ranges)) OF PCI- |

RangeElement OPTIONAL, -- Need N

| | |
|---|---|
| whiteCellsToRemoveList | PCI-RangeIndexList |

OPTIONAL, -- Need N

| | |
|---|---|
| whiteCellsToAddModList | SEQUENCE (SIZE (1..maxNrofPCI-Ranges)) OF PCI- |

```
RangeElement OPTIONAL, -- Need N
    ...,
    [[
```

| | |
|---|---|
| freqBandIndicatorNR | FreqBandIndicatorNR |

OPTIONAL, -- Need R

| | |
|---|---|
| measCycleSCell | ENUMERATED {sf160, sf256, sf320, sf512, sf640, sf1024, |

```
sf1280} OPTIONAL -- Need R
    ]],
    [[
```

| | |
|---|---|
| smtc3list-r16 | SSB-MTC3List-r16 |

OPTIONAL, -- Need R

| | |
|---|---|
| rmtc-Config-r16 | SetupRelease {RMTC-Config-r16} |

OPTIONAL, -- Need M

| | |
|---|---|
| t312-r16 | SetupRelease { T312-r16 } |

```
OPTIONAL -- Need M
    ]],
    [[
```

| | |
|---|---|
| measCycleDeactivatedSCG-List | MeasCycleDeactivatedSCG-List |

```
  OPTIONAL -- Need R
    ]]
}
```

| | |
|---|---|
| MeasCycleDeactivatedSCG-List ::= | SEQUENCE (SIZE (1..maxNrofMeasCycles)) OF |

MeasCycleDeactivatedSCG

| | |
|---|---|
| MeasCycleDeactivatedSCG ::= | SEQUENCE { |

| | |
|---|---|
| measCycle | ENUMERATED {sf160, sf256, sf320, sf512, sf640, sf1024, sf1280}, |
| criteria | CHOICE { |
| measId | MeasObjectId, |

...
}
-- TAG-MEASOBJECTNR-STOP
-- ASN1STOP

MeasObjectNR field descriptions

measCycleDeactivatedSCG-List
The parameter is used when the SCG is in deactivated state. gNB
configures the parameter whenever a PSCell is configured on the
frequency indicated by the measObjectNR. Value sf160 corresponds to
160 sub-frames, value sf256 corresponds to 256 sub-frames and so on.

The IE ReportConfigNR specifies criteria for triggering of an NR measurement reporting event or of a CHO or CPC event. For events labelled AN with N equal to 1, 2 and so on, measurement reporting events and CHO or CPC events are based on cell measurement results, which can either be derived based on SS/PBCH block or CSI-RS.
Event A1: Serving becomes better than absolute threshold;
Event A2: Serving becomes worse than absolute threshold;
Event A3: Neighbor becomes amount of offset better than PCell/PSCell;
Event A4: Neighbor becomes better than absolute threshold;
Event A5: PCell/PSCell becomes worse than absolute threshold1 AND Neighbor/SCell becomes better than another absolute threshold2;
Event A6: Neighbor becomes amount of offset better than SCell;
CondEvent A3: Conditional reconfiguration candidate becomes amount of offset better than PCell/PSCell;
CondEvent A5: PCell/PSCell becomes worse than absolute threshold1 AND Conditional reconfiguration candidate becomes better than another absolute threshold2;
For event I1, measurement reporting event is based on CLI measurement results, which can either be derived based on SRS-RSRP or CLI-RSSI.

Event I1: Interference becomes higher than absolute threshold.

ReportConfigNR information element

-- ASN1START
-- TAG-REPORTCONFIGNR-START

| | |
|---|---|
| ReportConfigNR ::= | SEQUENCE { |
| reportType | CHOICE { |
| periodical | PeriodicalReportConfig, |
| eventTriggered | EventTriggerConfig, |

...,

| | |
|---|---|
| reportCGI | ReportCGI, |
| reportSFTD | ReportSFTD-NR, |
| condTriggerConfig-r16 | CondTriggerConfig-r16, |
| cli-Periodical-r16 | CLI-PeriodicalReportConfig-r16, |
| cli-EventTriggered-r16 | CLI-EventTriggerConfig-r16, |
| measCycleTriggerConfig-r17 | MeasCycleTriggerConfig-r17 |

}
}

| | |
|---|---|
| MeasCycleTriggerConfig-r17 ::= | SEQUENCE { |

| | |
|---|---|
| eventId | CHOICE { |

| | |
|---|---|
| eventA3 | SEQUENCE { |
| a3-Offset | MeasTriggerQuantityOffset, |
| hysteresis | Hysteresis, |
| timeToTrigger | TimeToTrigger |

},

| | |
|---|---|
| eventA5 | SEQUENCE { |
| a5-Threshold1 | MeasTriggerQuantity, |
| a5-Threshold2 | MeasTriggerQuantity, |
| hysteresis | Hysteresis, |
| timeToTrigger | TimeToTrigger |

```
    }
  }
}
```

Some embodiments include redefinition of existing measCycleSCell scaling factor. In some embodiments, the interpretation of the parameter measCycleSCell, is extended to include Primary SCell (PSCell) when SCG, to which the PSCell belongs, is in deactivated state (in deactivated SCG mode of operation). In these embodiments, the obtained measurement cycle configuration contains the measCycleSCell.

In some embodiments, the extension only applies to PSCell when SCG is in deactivated state. The definition of measCycleSCell is modified as follows. The UE implementation is modified to account for the extended definition.

When gNB signals measObjectNR with measCycleSCell for a NR frequency on which PSCell is configured, the UE interprets this as a measurement cycle for the PSCell in the deactivated SCG, and thus carries out measurements on the PSCell when SCG is deactivated. When SCG is in activated state (or correspondingly “active”, “non-dormant”, etc), measCycleSCell is ignored/has no meaning for the PSCell

In these embodiments, when gNB configures measObjectNR with measCycleSCell for a NR frequency on which SCell is configured, and SCG is in deactivated state, the parameter has no meaning/is ignored by UE, and no UE measurements on the SCell are carried out. When SCG is in activated state, measCycleSCell is interpreted as in legacy, i.e., measurement cycle for deactivated SCell measurements. When SCG is in activated state and the SCell is in activated state, the parameter has no meaning to the UE/is ignored (same as in legacy).

Below is an example implementation in the RRC specification TS 38.331, according to some embodiments.

measCycleSCell
The parameter is used only when an SCell is configured on the frequency indicated by the
measObjectNR and is in deactivated state, or a PSCell in a SCG in deactivated state, see
TS 38.133. gNB configures the parameter whenever an SCell is configured on the
frequency indicated by the measObjectNR, but the field may also be signalled when an
SCell is not configured, or when a PSCell is configured. Value sf160 corresponds to 160
sub-frames, value sf256 corresponds to 256 sub-frames and so on.

TABLE 1
UE interpretation of and actions due to measCycleSCell (Variant 1)

| | PSCell | SCell | |
|---|---|---|---|
| SCG | measCycleSCell is ignored | SCell | measCycleSCell is ignored |
| activated | | active state | (legacy) |
| | | SCell | Carry out measurements |
| | | deactivated | on SCell with periodicity |
| | | state | influenced by/proportional |
| | | | to measCycleSCell |
| | | | (legacy) |
| SCG | Carry out measurements on | measCycleSCell is ignored. No | |
| deactivated | PSCell with periodicity | measurements on SCell are carried out. | |
| | influenced by/proportional | | |
| | to measCycleSCell | | |

In some embodiments, the extension applies to both PSCell and SCells when SCG is in deactivated state. The definition of measCycleSCell is modified as follows. The UE implementation is modified to account for the extended definition.

When gNB signals measObjectNR with measCycleSCell for a NR frequency on which PSCell is configured, the UE interprets this as a measurement cycle for the PSCell in the deactivated SCG, and thus carries out measurements on the PSCell when SCG is in deactivated state (or corresponding state or description “deactivated”, “dormant”, etc), and with a measurement periodicity that is influenced by or proportional to the measurement cycle. When SCG is in activated state (or corresponding state or description “active”, “non-dormant”, etc.), measCycleSCell is ignored/has no meaning for the PSCell

In these embodiments, when gNB configures measObjectNR with measCycleSCell for a NR frequency on which SCell is configured, and SCG is in deactivated state, the UE interprets the parameter as a measurement cycle for the SCell in the deactivated SCG, and thus carries out measurements on the SCell when SCG is deactivated, and with a measurement periodicity that is influenced by or proportional to the measurement cycle. When SCG is in activated state, the UE interprets the measCycleSCell parameter in the same way as in legacy, i.e., it represents a measurement cycle for SCell in deactivated state, but it has no meaning for a SCell in activated state.

Below is an example implementation in the RRC specification TS 38.331, according to some embodiments.

measCycleSCell
The parameter is used only when an SCell is configured on the frequency indicated by the
measObjectNR and is in deactivated state, or an SCell or PSCell in a SCG in deactivated
state, see TS 38.133. gNB configures the parameter whenever an SCell is configured on
the frequency indicated by the measObjectNR, but the field may also be signalled when an
SCell is not configured, or when a PSCell is configured. Value sf160 corresponds to 160
sub-frames, value sf256 corresponds to 256 sub-frames and so on.

TABLE 2
UE interpretation of and actions due to measCycleSCell (Variant 2)

| | PSCell | SCell | |
|---|---|---|---|
| SCG | measCycleSCell is ignored | SCell | measCycleSCell is ignored |
| activated | | active state | (legacy) |
| | | SCell | Carry out measurements |
| | | deactivated | on SCell with periodicity |
| | | state | influenced by/proportional |
| | | | to measCycleSCell |
| | | | (legacy) |
| SCG | Carry out measurements on | Carry out measurements on SCell with | |
| deactivated | PSCell with periodicity | periodicity influenced by/proportional | |
| | influenced by/proportional | to measCycleSCell | |
| | to measCycleSCell | | |

In some embodiments, the extension applies to PSCell and possibly SCells when SCG is in deactivated state, and further depends on whether it is indicated that measurements on the cell shall be carried out when SCG is in deactivated state. These embodiments are a combination of the variants above, and the “configured subset of measurements” embodiment.

Below is an example implementation in the RRC specification TS 38.331, according to some embodiments.

TABLE 3
UE interpretation of and actions due to measCycleSCell (Variant 3)

| | PSCell | | SCell | |
|---|---|---|---|---|
| SCG | measCycleSCell is ignored | | SCell active | measCycleSCell is |
| activated | | | state | ignored (legacy) |
| | | | SCell | Carry out |
| | | | deactivated | measurements on |
| | | | state | SCell with |
| | | | | periodicity influenced |
| | | | | by/proportional to |
| | | | | measCycleSCell |
| | | | | (legacy) |
| SCG | measurement | Carry out | measurement | Carry out |
| deactivated | indicated | measurements | indicated | measurements on |
| | | on PSCell with | | SCell with |
| | | periodicity | | periodicity influenced |
| | | influenced by/ | | by/proportional to |
| | | proportional to | | measCycleSCell |
| | | measCycleSCell | | |
| | measurement | measCycleSCell | measurement | measCycleSCell is |
| | not indicated | is ignored. No | not indicated | ignored. No |
| | | measurements | | measurements on |
| | | on PSCell are | | SCell are carried |
| | | carried out. | | out. |

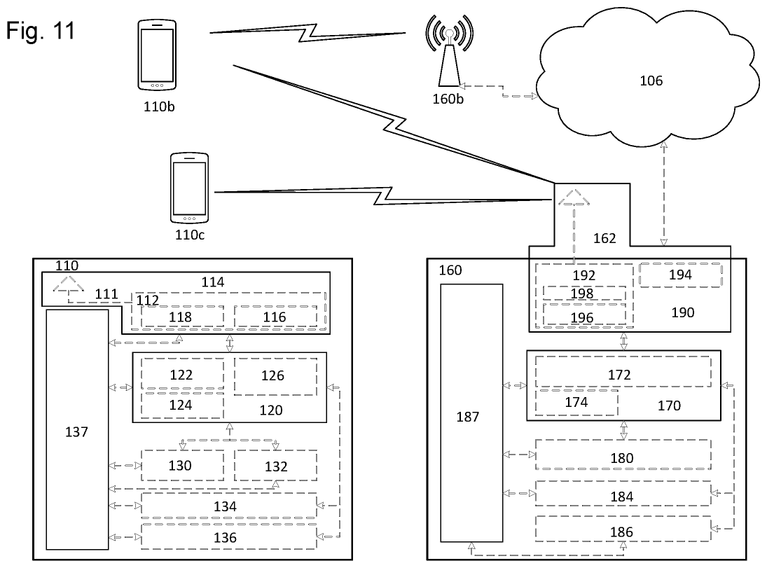

FIG. 11 illustrates an example wireless network, according to certain embodiments. The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network.

Examples of network nodes include, but are not limited to, access points (APs) (e.g., radio access points), base stations (BSs) (e.g., radio base stations, Node Bs, evolved Node Bs (eNBs) and NR NodeB s (gNBs)). Base stations may be categorized based on the amount of coverage they provide (or, stated differently, their transmit power level) and may then also be referred to as femto base stations, pico base stations, micro base stations, or macro base stations.

A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLC s), and/or MDT s.

As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 11, network node 160 includes processing circuitry 170, device readable medium 180, interface 190, auxiliary equipment 184, power source 186, power circuitry 187, and antenna 162. Although network node 160 illustrated in the example wireless network of FIG. 11 may represent a device that includes the illustrated combination of hardware components, other embodiments may comprise network nodes with different combinations of components.

It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node.

In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality.

For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162.

Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160.

For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 11 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air.

In some embodiments, a WD may be configured to transmit and/or receive information without direct human interaction. For instance, a WD may be designed to transmit information to a network on a predetermined schedule, when triggered by an internal or external event, or in response to requests from the network.

Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one example, the WD may be a UE implementing the 3GPP narrow band internet of things (NB-IoT) standard. Examples of such machines or devices are sensors, metering devices such as power meters, industrial machinery, or home or personal appliances (e.g. refrigerators, televisions, etc.) personal wearables (e.g., watches, fitness trackers, etc.).

In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114.

Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips.

In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner.

In any of those embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected).

User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry.

Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

Although the subject matter described herein may be implemented in any appropriate type of system using any suitable components, the embodiments disclosed herein are described in relation to a wireless network, such as the example wireless network illustrated in FIG. 11. For simplicity, the wireless network of FIG. 11 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

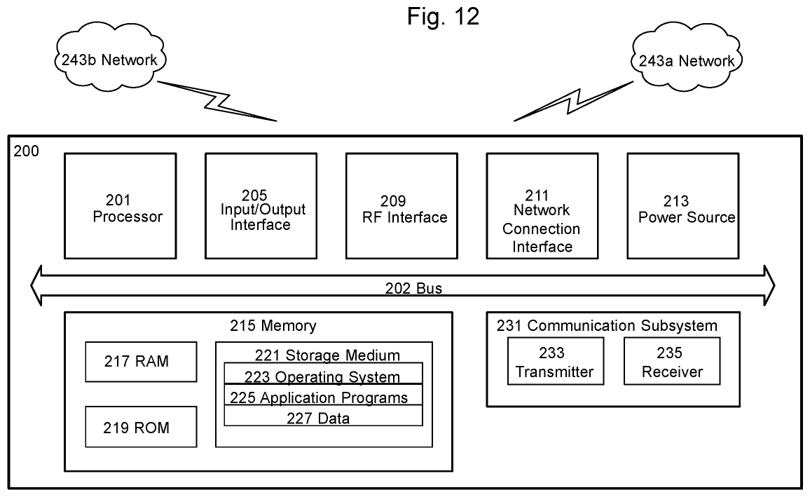

FIG. 12 illustrates an example user equipment, according to certain embodiments. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 12, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 12 is a UE, the components discussed herein are equally applicable to a WD, and vice-versa.

In FIG. 12, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 213, and/or any other component, or any combination thereof. Storage medium 221 includes operating system 223, application program 225, and data 227. In other embodiments, storage medium 221 may include other similar types of information. Certain UEs may use all the components shown in FIG. 12, or only a subset of the components. The level of integration between the components may vary from one UE to another UE. Further, certain UEs may contain multiple instances of a component, such as multiple processors, memories, transceivers, transmitters, receivers, etc.

In FIG. 12, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205.

An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof.

UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 12, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory.

Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 12, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

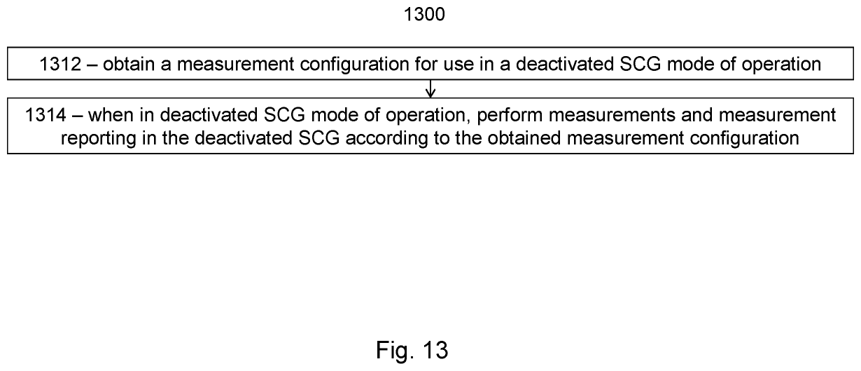

FIG. 13 is a flowchart illustrating an example method in a wireless device, according to certain embodiments. In particular embodiments, one or more steps of FIG. 13 may be performed by wireless device 110 described with respect to FIG. 11. The wireless device is wireless device configured to operate in MR-DC to perform measurements in a deactivated SCG mode of operation.

The method may begin at step 1312, where the wireless device (e.g., wireless device 110) obtains a measurement configuration for use in a deactivated SCG mode of operation. The measurement configuration is more relaxed than a measurement configuration for use in an activated SCG mode of operation. For example, wireless device 110 may receive the measurement configuration from network node 160.

In particular embodiments, the measurement configuration for use in deactivated SCG mode of operation comprises a subset of a measurement configuration for use in activated SCG mode of operation. The subset may comprise one or more of: a subset of cells to measure; a subset of frequencies to measure; and a subset of measurement objects.

In particular embodiments, the measurement configuration for use in deactivated SCG mode of operation comprises a measurement cycle (e.g., for PSCell or SCell).

In particular embodiments, the measurement configuration for use in deactivated SCG mode of operation further comprises one or more threshold values associated with one or more configurations. The measurement configuration for use in deactivated SCG mode of operation may comprise a first measurement configuration for use with a first group of one or more cells and a second measurement configuration for use with a second group of one or more cells.

The measurement configuration may comprise any of the measurement configurations described with respect to the embodiments and examples described above.

At step 1314, when in deactivated SCG mode of operation, the wireless device performs measurements and measurement reporting in the deactivated SCG according to the obtained measurement configuration.

Modifications, additions, or omissions may be made to method 1300 of FIG. 13. Additionally, one or more steps in the method of FIG. 13 may be performed in parallel or in any suitable order.

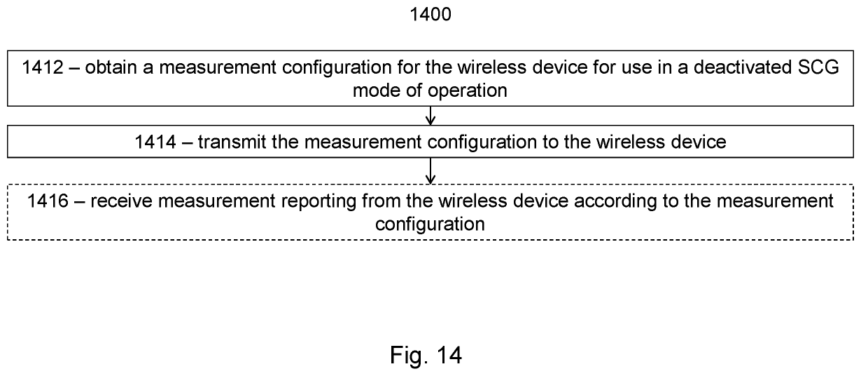

FIG. 14 is a flowchart illustrating an example method in a network node, according to certain embodiments. In particular embodiments, one or more steps of FIG. 14 may be performed by network node 160 described with respect to FIG. 11. The network node is configured to communicate with a wireless device operating in MR-DC and operable to perform measurements in a deactivated SCG mode of operation.

The method begins at step 1412, where a network node (e.g., network node 160) obtains a measurement configuration for the wireless device for use in a deactivated SCG mode of operation. The measurement configuration is more relaxed than a measurement configuration for use in an activated SCG mode of operation.

In particular embodiments, the measurement configuration for use in deactivated SCG mode of operation comprises a subset of a measurement configuration for use in activated SCG mode of operation. The subset may comprise one or more of: a subset of cells to measure; a subset of frequencies to measure; and a subset of measurement objects.

In particular embodiments, the measurement configuration for use in deactivated SCG mode of operation comprises a measurement cycle (e.g., for PSCell or SCell).

In particular embodiments, the measurement configuration for use in deactivated SCG mode of operation further comprises one or more threshold values associated with one or more configurations. The measurement configuration for use in deactivated SCG mode of operation may comprise a first measurement configuration for use with a first group of one or more cells and a second measurement configuration for use with a second group of one or more cells.

The measurement configuration may comprise any of the measurement configurations described with respect to the embodiments and examples described above.

At step 1414, the network node transmits the measurement configuration to the wireless device, and at step 1416 the network node may receive measurement reporting from the wireless device according to the measurement configuration.

Modifications, additions, or omissions may be made to method 1400 of FIG. 14. Additionally, one or more steps in the method of FIG. 14 may be performed in parallel or in any suitable order.

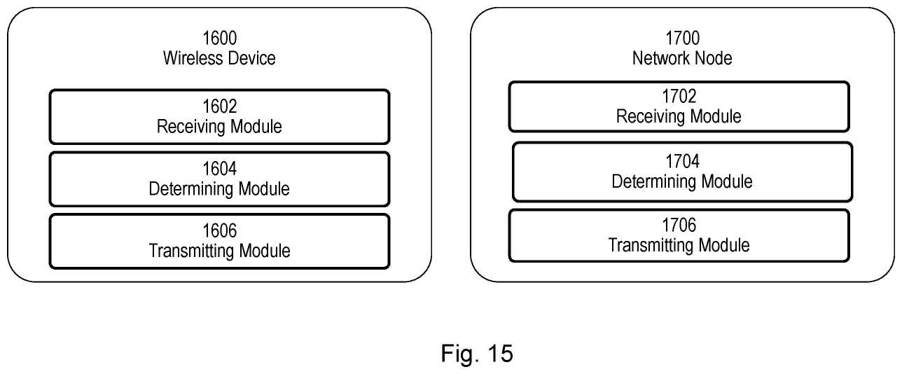

FIG. 15 illustrates a schematic block diagram of two apparatuses in a wireless network (for example, the wireless network illustrated in FIG. 11). The apparatuses include a wireless device and a network node (e.g., wireless device 110 and network node 160 illustrated in FIG. 11). Apparatuses 1600 and 1700 are operable to carry out the example methods described with reference to FIGS. 13 and 14, respectively, and possibly any other processes or methods disclosed herein. It is also to be understood that the methods of FIGS. 13 and 14 are not necessarily carried out solely by apparatuses 1600 and/or 1700. At least some operations of the methods can be performed by one or more other entities.

Virtual apparatuses 1600 and 1700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments.

In some implementations, the processing circuitry may be used to receiving module 1602, determining module 1604, transmitting module 1606, and any other suitable units of apparatus 1600 to perform corresponding functions according one or more embodiments of the present disclosure. Similarly, the processing circuitry described above may be used to cause receiving module 1702, determining module 1704, transmitting module 1706, and any other suitable units of apparatus 1700 to perform corresponding functions according one or more embodiments of the present disclosure.

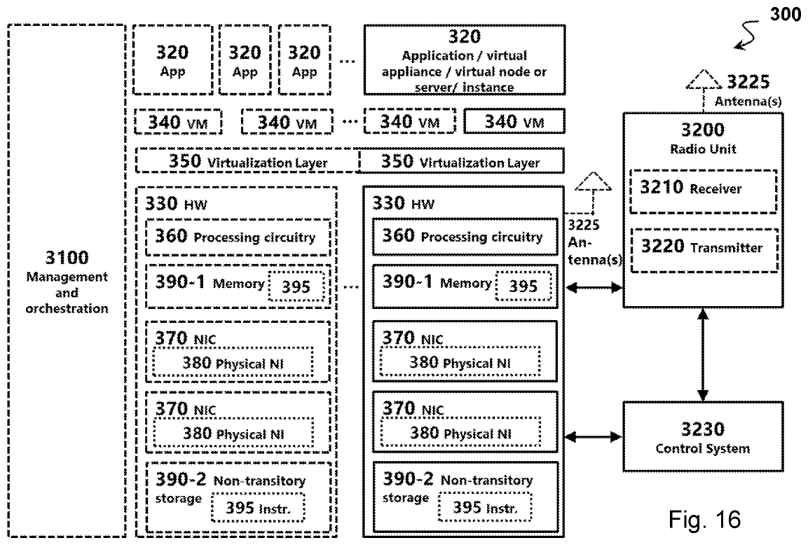

FIG. 16 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 16, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

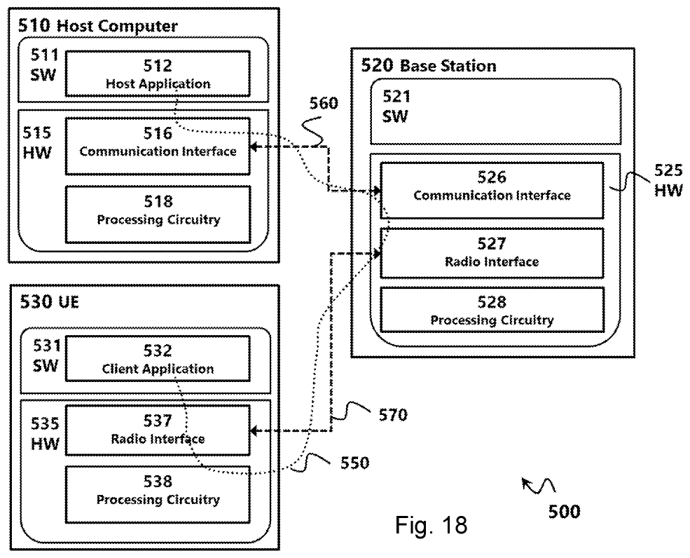

Still in the context of NFV, Virtual Network Function (VNF) is responsible for handling specific network functions that run in one or more virtual machines 340 on top of hardware networking infrastructure 330 and corresponds to application 320 in FIG. 18.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be effected with the use of control system 3230 which may alternatively be used for communication between the hardware nodes 330 and radio units 3200.

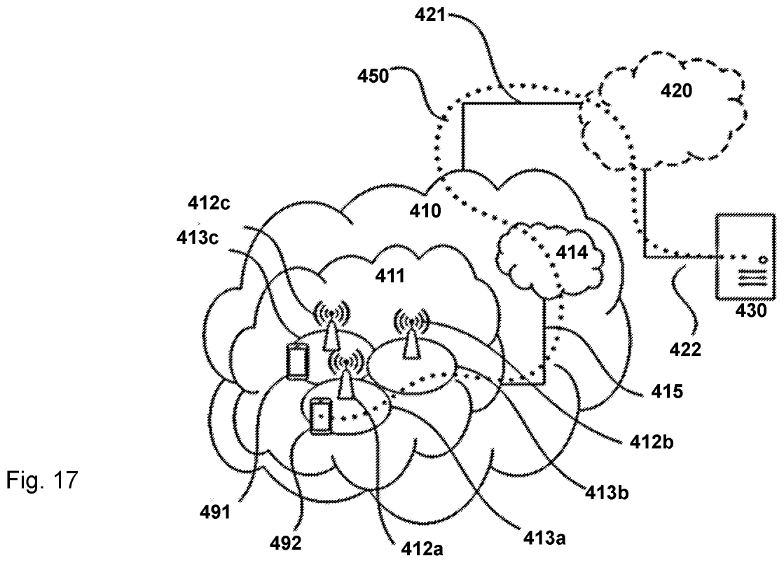

With reference to FIG. 17, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NB s, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 17 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

FIG. 18 illustrates an example host computer communicating via a base station with a user equipment over a partially wireless connection, according to certain embodiments. Example implementations, in accordance with an embodiment of the UE, base station and host computer discussed in the preceding paragraphs will now be described with reference to FIG. 18. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 18) served by base station 520. Communication interface 526 may be configured to facilitate connection 560 to host computer 510. Connection 560 may be direct, or it may pass through a core network (not shown in FIG. 18) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 18 may be similar or identical to host computer 430, one of base stations 412a, 412b, 412c and one of UEs 491, 492 of FIG. 16, respectively. This is to say, the inner workings of these entities may be as shown in FIG. 18 and independently, the surrounding network topology may be that of FIG. 16.

In FIG. 18, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., based on load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the signaling overhead and reduce latency, which may provide faster internet access for users.

A measurement procedure may be provided for monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

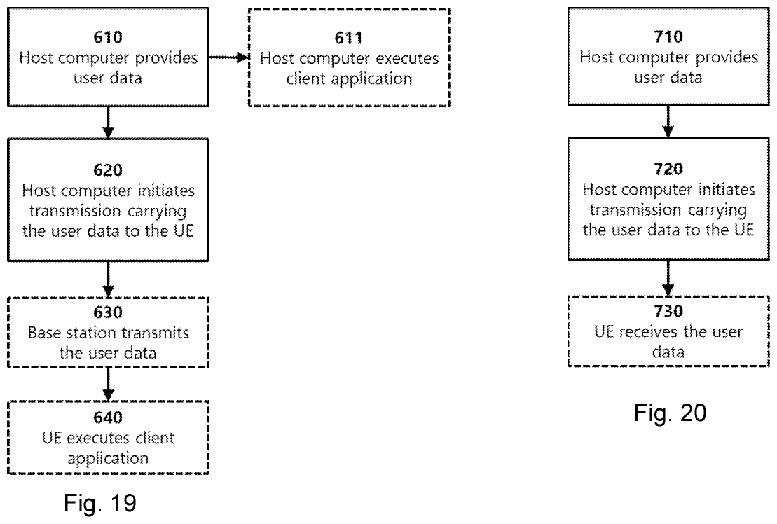

FIG. 19 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 19 will be included in this section.

In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 20 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 20 will be included in this section.

In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

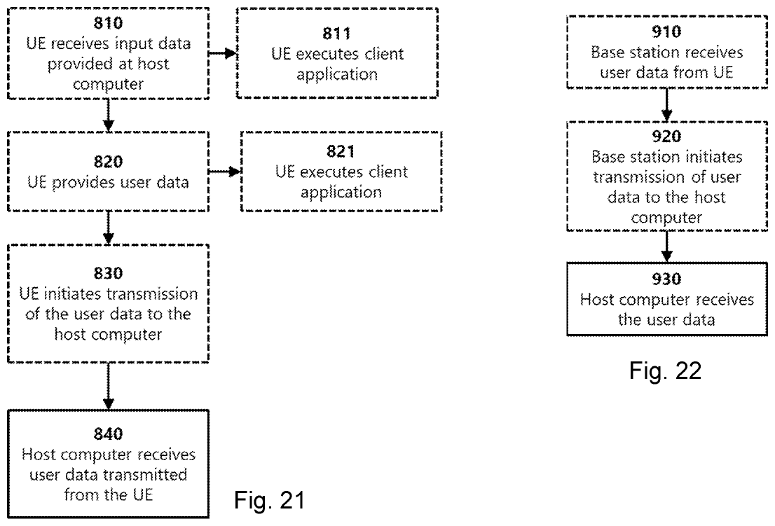

FIG. 21 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 21 will be included in this section.

In step 810 (which may be optional), the UE receives input data provided by the host computer. Additionally, or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments de scribed throughout this disclosure.

FIG. 22 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 22 will be included in this section.

In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

At least some of the following abbreviations may be used in this disclosure. If there is an inconsistency between abbreviations, preference should be given to how it is used above. If listed multiple times below, the first listing should be preferred over any subsequent listing(s).

1. A method performed by a wireless device configured to operate in multi-radio dual connectivity, MR-DC, to perform measurements in a deactivated secondary cell group, SCG, mode of operation, the method comprising:
obtaining a measurement configuration for use in a deactivated SCG mode of operation, wherein the measurement configuration is more relaxed than a measurement configuration for use in an activated SCG mode of operation; and
when in deactivated SCG mode of operation, performing measurements and measurement reporting in the deactivated SCG according to the obtained measurement configuration.

2. The method of claim 1, wherein the measurement configuration for use in deactivated SCG mode of operation comprises a subset of a measurement configuration for use in activated SCG mode of operation.

3. The method of claim 2, wherein the subset comprises one or more of:
a subset of cells to measure;
a subset of frequencies to measure; and
a subset of measurement objects.

4. The method of claim 1, wherein the measurement configuration for use in deactivated SCG mode of operation comprises a measurement cycle.

5. The method of claim 4, wherein the measurement cycle comprises a measurement cycle for at least one of a PSCell and an SCell.

6. The method of claim 1, wherein the measurement configuration for use in deactivated SCG mode of operation further comprises one or more threshold values associated with one or more configurations.

7. The method of claim 1, wherein the measurement configuration for use in deactivated SCG mode of operation comprises a first measurement configuration for use with a first group of one or more cells and a second measurement configuration for use with a second group of one or more cells.

8. A wireless device capable of operating in multi-radio dual connectivity, MR-DC, to perform measurements in a deactivated secondary cell group, SCG, mode of operation, the wireless device comprising processing circuitry operable to:
obtain a measurement configuration for use in a deactivated SCG mode of operation, wherein the measurement configuration is more relaxed than a measurement configuration for use in an activated SCG mode of operation; and
when in deactivated SCG mode of operation, perform measurements and measurement reporting in the deactivated SCG according to the obtained measurement configuration.

9. The wireless device of claim 8, wherein the measurement configuration for use in deactivated SCG mode of operation comprises a subset of a measurement configuration for use in activated SCG mode of operation.

10. The wireless device of claim 9, wherein the subset comprises one or more of:
a subset of cells to measure;
a subset of frequencies to measure; and
a subset of measurement objects.

11. The wireless device of claim 8, wherein the measurement configuration for use in deactivated SCG mode of operation comprises a measurement cycle.

12. The wireless device of claim 11, wherein the measurement cycle comprises a measurement cycle for at least one of a PSCell and an SCell.

13. The wireless device of claim 8, wherein the measurement configuration for use in deactivated SCG mode of operation further comprises one or more threshold values associated with one or more configurations.

14. The wireless device of claim 8, wherein the measurement configuration for use in deactivated SCG mode of operation comprises a first measurement configuration for use with a first group of one or more cells and a second measurement configuration for use with a second group of one or more cells.

15. A method performed by a network node configured to communicate with a wireless device operating in multi-radio dual connectivity, MR-DC, and operable to perform measurements in a deactivated secondary cell group, SCG, mode of operation, the method comprising:
obtaining a measurement configuration for the wireless device for use in a deactivated SCG mode of operation, wherein the measurement configuration is more relaxed than a measurement configuration for use in an activated SCG mode of operation; and
transmitting the measurement configuration to the wireless device.

16. The method of claim 15, further comprising receiving measurement reporting from the wireless device according to the measurement configuration.

17. The method of claim 15, wherein the measurement configuration for use in deactivated SCG mode of operation comprises a subset of a measurement configuration for use in activated SCG mode of operation.

18. The method of claim 17, wherein the subset comprises one or more of:
a subset of cells to measure;
a subset of frequencies to measure; and
a subset of measurement objects.

19.-22. (canceled)

23. A network node configured to communicate with a wireless device operating in multi-radio dual connectivity, MR-DC, and operable to perform measurements in a deactivated secondary cell group, SCG, mode of operation, the network node comprising processing circuitry operable to:
obtain a measurement configuration for the wireless device for use in a deactivated SCG mode of operation, wherein the measurement configuration is more relaxed than a measurement configuration for use in an activated SCG mode of operation; and
transmit the measurement configuration to the wireless device.

24. The network node of claim 23, the processing circuitry further operable to receive measurement reporting from the wireless device according to the measurement configuration.

25. The network node of claim 23, wherein the measurement configuration for use in deactivated SCG mode of operation comprises a subset of a measurement configuration for use in activated SCG mode of operation.

26. The network node of claim 25, wherein the subset comprises one or more of:
a subset of cells to measure;
a subset of frequencies to measure; and
a subset of measurement objects.

27. The network node of claim 23, wherein the measurement configuration for use in deactivated SCG mode of operation comprises a measurement cycle.

28. The network node of claim 27, wherein the measurement cycle comprises a measurement cycle for at least one of a PSCell and an SCell.

29. The network node of claim 23, wherein the measurement configuration for use in deactivated SCG mode of operation further comprises one or more threshold values associated with one or more configurations.

30. The network node of claim 23, wherein the measurement configuration for use in deactivated SCG mode of operation comprises a first measurement configuration for use with a first group of one or more cells and a second measurement configuration for use with a second group of one or more cells.
